(19) United States
(12) Patent Application Publication
(10) Pub. No.: US 2026/0100569 A1
(43) Pub. Date: Apr. 9, 2026

(54) WORKFLOW TO CONVERT DUAL ARRIVAL EVENTS INTO CURTAIN PLOT SECTION OF FORMATION SLOWNESS AND LOGS OF TOOL LAYER AND SHOULDER BED SLOWNESS

(71) Applicant: SCHLUMBERGER TECHNOLOGY CORPORATION, Sugar Land, TX (US)

(72) Inventors: Nicholas Norman BENNETT, Cambridge, MA (US); Jingxuan LIU, Cambridge, MA (US); Xin LIU, Shifang city (CN); Ting LEI, Arlington, MA (US)

(21) Appl. No.: 18/993,055

(22) PCT Filed: Jul. 12, 2023
(86) PCT No.: PCT/US2023/027519

§ 371 Date: Jan. 10, 2025

Related U.S. Application Data
(60) Provisional application No. 63/368,177, filed on Jul. 12, 2022.

(51) Int. Cl. H02G 15/24; E21B 17/02; H02G 15/013

(52) U.S. Cl. CPC H02G 15/24; E21B 17/028; H02G 15/013

(57) ABSTRACT

An automated workflow for processing dual arrival events consisting of: (1) an automated time pick that located and characterized dual compressional and shear arrival events present in acoustic waveform measurements; and (2) a ray tracing inversion procedure that inverted these time picks and constructed a locally layered formation model of slowness along the well trajectory. The disclosed workflow embodiments provide the following benefits: (1) an automated time pick which estimates the variation of the arrival event with measured depth and determines whether the shoulder bed is above or below the well track; and (2) a ray tracing inversion that determines the raypath type of the dual arrival event. The disclosed workflow embodiments provide a log display of tool layer and shoulder bed compressional and shear slowness which is useful for making correct porosity, VP/VS, and Poisson ratio estimates as well as other geomechanics answers.

### CROSS-REFERENCE TO RELATED APPLICATION

This application is a National Stage Entry of International Application No. PCT/US2023/027519, filed Jul. 12, 2023, which claims priority to and the benefit of U.S. Provisional Application No. 63/368,177, entitled “Workflow to Convert Dual Arrival Events into Curtain Plot Section of Formation Slowness and Logs of Tool Layer and Shoulder Bed Slowness,” filed Jul. 12, 2022, which is hereby incorporated by reference in its entirety for all purposes.

### BACKGROUND

### Field

The present disclosure generally relates to methods of interpretation of dual arrival events that occur in sonic logs.

### Description of Related Art

Dual arrival events are well known to occur in sonic logs acquired in high angle and horizontal wells. They present a variety of interpretation challenges. In particular, dual arrival events can complicate the process of determining compressional slowness and porosity in the formation layer where the sonic tool is located, particularly when the sonic tool is located close to multiple formation layers.

Dual compressional and shear arrival events often occur in high angle wells where the compressional P and shear S waves propagate not just within the layer containing the tool sonde (the ‘tool layer arrivals’) but also refract (or also reflect) along nearby shoulder beds (the ‘shoulder bed arrivals’).

### BRIEF DESCRIPTION OF THE FIGURES

Certain embodiments, features, aspects, and advantages of the disclosure will hereafter be described with reference to the accompanying drawings, wherein like reference numerals denote like elements. It should be understood that the accompanying figures illustrate the various implementations described herein and are not meant to limit the scope of various technologies described herein.

FIG. 1 depicts three examples of projected slowness time coherence (STC) logs where dual arrival events signatures are present in both the compressional (DTCO) and shear (DTSH) logs.

FIG. 2 depicts an illustration of dual arrival events highlighting shoulder bed and tool layer arrivals.

FIGS. 3A through 3C depict single station slowness-time coherence-based time pick approach.

FIG. 4 depicts a workflow diagram, according to one or more embodiments.

FIG. 5 depicts a formation model with tool layer, shoulder bed, and well track having a 1° dip relative to the shoulder bed boundary, according to an embodiment of the disclosure.

FIGS. 6A through 6C depict a common offset (FIG. 6A), common azimuth (FIG. 6B), and common ring (FIG. 6C) gather views of an acoustic logging tool waveforms simulated using formation model described in FIG. 5 with the labeled tool layer and shoulder bed arrivals.

FIG. 7 depicts a formation model with a tool layer, shoulder bed and well track having a 1° dip relative to the shoulder bed boundary also shown in FIG. 5, wherein the tool sonde is close to the shoulder bed boundary.

FIGS. 8A through 8C depicts a common offset (FIG. 8A), common azimuth (FIG. 8B), and common ring (FIG. 8C) views of Sonic Scanner waveforms simulated using formation model described in FIG. 7 with the labeled tool layer and shoulder bed arrivals.

FIG. 9 depicts an illustration of tau-P transform in the common offset gather (COG) domain where linear events in the COG domain are mapped to peaks in the COG tau-P domain. Tau-P peak coordinates correspond to the slope and y-intercept of the line segment along which the arrival event is located.

FIG. 10 depicts an illustration of tau-P transform in the common shot or azimuth gather (CSG) domain where linear events in the CSG domain are mapped to peaks in the CSG tau-P domain.

FIG. 11 depicts an illustration of tau-P transform in the common ring gather (CRG) domain.

FIG. 12A shows reflected arrival event visible in COG view of acoustic logging tool waveforms, FIG. 12B shows corresponding COG tau-P processing where undulations in the waveforms correspond to undulations in the tau-P peak signature, and FIG. 12C shows the same tau-P result after performing coherent energy post-processing.

FIG. 13A shows 3D slice of CSG, COG, CRG tau-P processing for reflection from field measurements shown in FIG. 12A, while FIG. 13B shows the same 3D tau-P slice after convolving the tau-P processing result in T with a boxcar function of duration Δ=0.2 milliseconds.

FIGS. 14A though 14F depict 2D slices of 4D tau-P cube for waveform measurements described in FIG. 5 and FIGS. 6A through 6C. FIGS. 14A through 14C show the shoulder bed arrival peak, while FIGS. 14D through 14F show the tool layer arrival peak.

FIG. 15A through 15F depict automated time picks for modeled Sonic Scanner measurements described in FIG. 5 and FIGS. 6A through 6C.

FIGS. 16A through 16F show 2D slices of 4D tau-P cube for waveform measurements described in FIG. 7 and FIG. 8, while FIGS. 16G through 16L show corresponding time picks overlayed on waveform measurements.

FIGS. 17A through 17C depict field data example measurements. FIG. 17A shows shoulder bed and tool layer P and S arrivals in a common offset gather (COG) view of Sonic Scanner waveforms. FIG. 17B shows slowness time coherence (STC) image log indicating the presence of both dual P and S arrivals. FIG. 17C shows a density image indicating that a denser layer is above the well track through this measured depth zone.

FIGS. 18A through 18D depict 2D slices of 4D tau-P cube for waveform field measurements shown in FIG. 17A.

FIGS. 19A through 19D depict automated time pick results for Sonic Scanner waveforms shown in FIG. 17A.

FIG. 20 depicts standard commercial compressional and shear slowness logs (DTCO and DTSH) alongside slowness logs (DTCOT, DTCOS, DTSHT, and DTSHS) derived from automated time pick. DTCOT and DTSHT correspond to the tool layer compressional and shear, while DTCOS and DTSHS correspond to the shoulder bed compressional and shear.

FIGS. 21A through 21D depict an illustration of four commonly observed dual arrival raypath types: PPP refraction, PP reflection, SSS refraction, and SS reflection.

FIGS. 22A and 22B depict labeled raypaths in PPP and PP ray tracings, respectively.

FIG. 23 depicts an illustration of ray tracing inversion parameters of interest.

FIGS. 24A through 24D depict input data for ray tracing inversion: forward modeled travel times

$${tt}_{j}^{i}$$

and slowness values

$${s}_{COG}^{*} , {s}_{CSG}^{*}$$

associated with the four raypath types illustrated in FIGS. 21A through 21D.

FIG. 25 depicts a field data example from FIGS. 17A through 17C with arrival events marked using the automated time pick.

FIGS. 26A through 26D depict input data used for ray tracing inversion obtained from automated time picks shown in FIG. 25.

FIGS. 27A and 27B depict an illustration of raypaths and curtain section derived from ray tracing inversion.

FIG. 28 depicts methods of constructing curtain section inversion result for single PPP time pick corresponding to the synthetic example from FIG. 21A.

FIGS. 29A and 29B depict a final curtain plot sections showing inversion result for PPP synthetic example from FIG. 21A.

FIGS. 30A and 30B depict final curtain plot sections produced by the ray tracing inversion for the field measurements shown in FIG. 25.

FIGS. 31A and 31B depict PPP and SSS curtain plot sections of FIGS. 30A and 30B shown in a 3D geo-modeling software (Petrel) along a well trajectory.

FIG. 32 depicts further 3D results derived from workflow.

### DETAILED DESCRIPTION

In the following description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are, of course, merely examples and are not intended to be limiting. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

As used herein, the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”; “upper” and “lower”; “top” and “bottom”; and other like terms indicating relative positions to a given point or element are utilized to more clearly describe some elements. Commonly, these terms relate to a reference point at the surface from which drilling operations are initiated as being the top point and the total depth being the lowest point, wherein the well (e.g., wellbore, borehole) is vertical, horizontal or slanted relative to the surface.

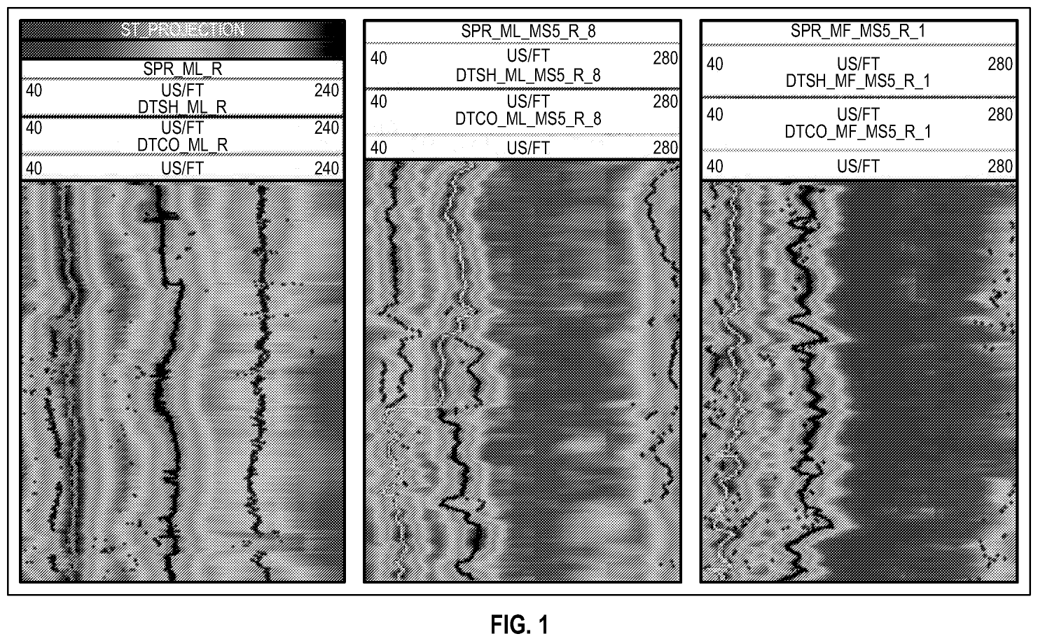

Dual arrival events, as illustrated in FIG. 1, are well known to occur in sonic logs acquired in high angle and horizontal wells. They present a variety of interpretation challenges. In particular, dual arrival events can complicate the process of determining compressional slowness and porosity in the formation layer where the sonic tool is located, particularly when the sonic tool is located close to multiple formation layers.

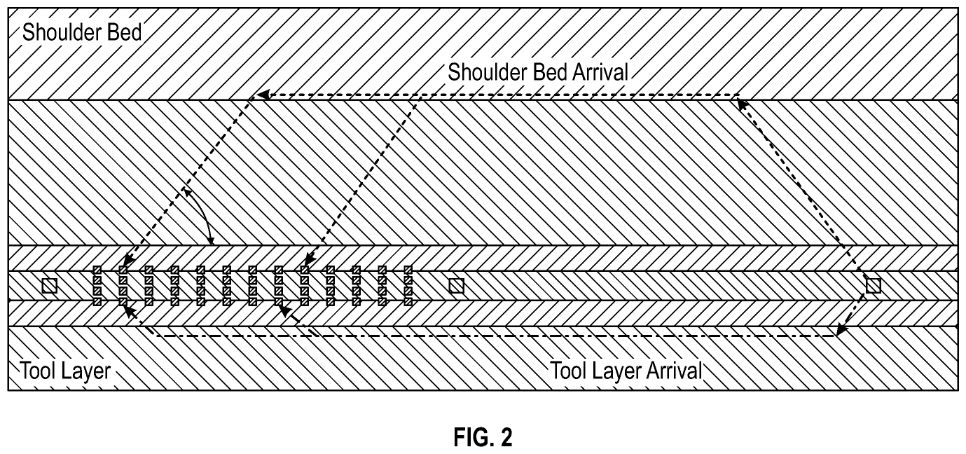

Dual compressional and shear arrival events often occur in high angle wells where the compressional P and shear S waves propagate not just within the layer containing the tool sonde (the ‘tool layer arrivals’) but also refract (or also reflect) along nearby shoulder beds (the ‘shoulder bed arrivals’) as illustrated in FIG. 2. The dual arrivals signatures shown in the logs of FIG. 1 correspond to the apparent slowness of these tool layer and shoulder bed arrivals.

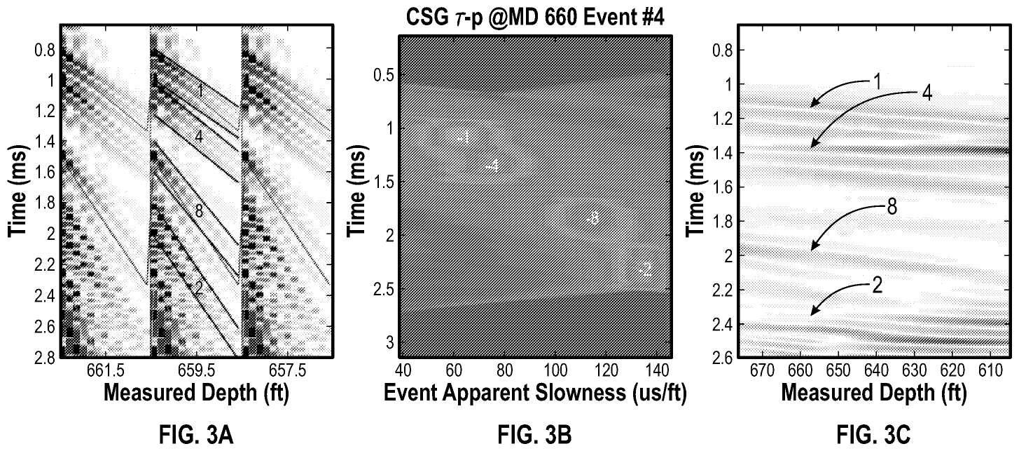

Disclosed herein are improvements over automated time pick built from a single station slowness-time coherence (STC) where dual arrival events were identified and then processed to map nearby shoulder beds. FIG. 3A shows a common shot gather (CSG) view of simulated waveform measurements with events marked in FIG. 3B. FIG. 3B shows slowness time coherence processing of waveforms at 659.5 ft MD. FIG. 3C shows common offset gather (COG) view of waveforms with events 1, 2, 4, and 8 marked by hand at 659.5 ft MD.

FIG. 3B shows a slowness-time coherence (STC) analysis of the waveform events marked in the left panel with indices #1, 4, 8, and 2. If one identifies event #1 as a dual arrival compressional arrival from a shoulder bed with apparent slowness

$${s}_{CSG}^{*} = 64 μs / ft$$

and arrival time τ*=1.094 ms, then one can use a ray tracing to compute the associated distance to the shoulder bed as approximately 1.3 ft assuming that the shoulder bed and well track are parallel to one another. We can then process event #1 using the 3D slowness time coherence (3D STC) to determine whether the shoulder bed is above or below the well track. This single station approach is most useful for mapping shoulder beds and tool layers along the well track.

However, the single station STC time pick approach does not provide an automated labeling of the dual arrival events in FIGS. 3A and 3B. The single station computation above requires expert interpretation of event #1 as a shoulder bed P refraction. Correctly labeling the dual arrival event as a P reflection, P refraction, S refraction, or S reflection is very important for determining what information a dual arrival event can provide about the shoulder bed. Furthermore, the single station STC time pick does not capture the lateral continuity of the event. FIG. 3C depicts a common offset (COG) or single sensor view of the waveforms as a function of measured depth is depicted, and events are marked with indices #1, 4, 8, and 2 at measured depth 660 ft on the display. In the disclosed embodiments of disclosed methods, allow for automated time pick to capture this lateral continuity of the arrival event in order to quantify how the dual arrival event arrival time varies as a function of measured depth. This can be used to further constrain the ray tracing inversion, particularly for determining the raypath type of the dual arrival event.

The 3D STC analysis performed as a subsequent and separate step following the STC time pick depends strongly on the estimated value for τ*, the arrival time of the selected event. Small inaccuracies or noise in τ* can mean that the 3D STC azimuth information is contaminated by events other than the dual arrival event. Thus, the disclosed methods for automated time pick capture the azimuthal variation of the arrival event as a function of nominal receiver azimuth and so determine whether the shoulder bed is above or below the well track.

Peak finding using a single station STC can be a very noisy procedure and can lead to a lot of false peaks that affect the interpretability of the resulting curtain plot section. Also, shifts in the STC peak locations due to noise can affect the ray tracing inversion accuracy as well. The disclosed methods for automated time pick can stack the dual arrival events as a function of measured depth, source-receiver offset, as well as nominal receiver azimuth, the signal-to-noise ratio of the time pick may be increased relative to the background noise.

The disclosed methods perform physics modeling of dual arrival events to understand the details of how dual arrival events present themselves to the 3D acoustic receiver array sensors, particularly as a function of measured depth, source-receiver offset, and nominal azimuth; develop an automated time pick that follows that physics modeling and captures the arrival time variations of dual arrival events as a function of measured depth, source-receiver offset, and nominal azimuth; develop a ray tracing inversion which can utilize the information produced by this new time pick to (a) automatically identify the raypath type of the dual arrival event; (b) automatically differentiate the shoulder bed arrival events from the direct tool layer arrivals; (c) produce a log of tool layer and shoulder bed slowness to aid in formation evaluation; and (d) produce a curtain plot section of formation slowness along the well track; (e) produce a log of true dip and azimuth describing the local orientation of the shoulder bed boundary as a function of measured depth.

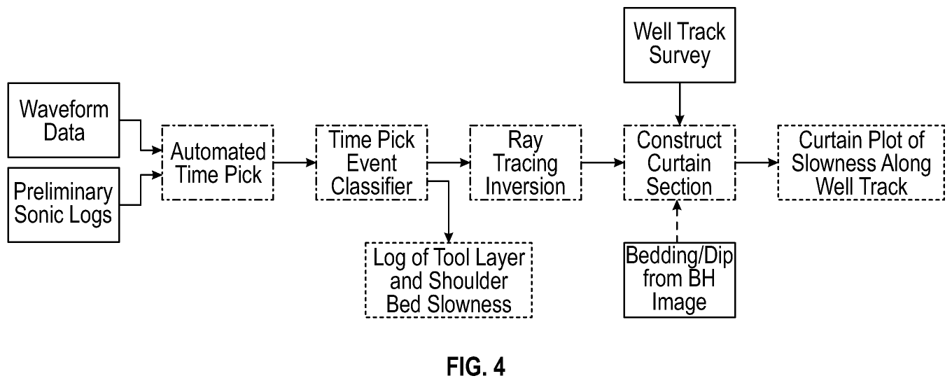

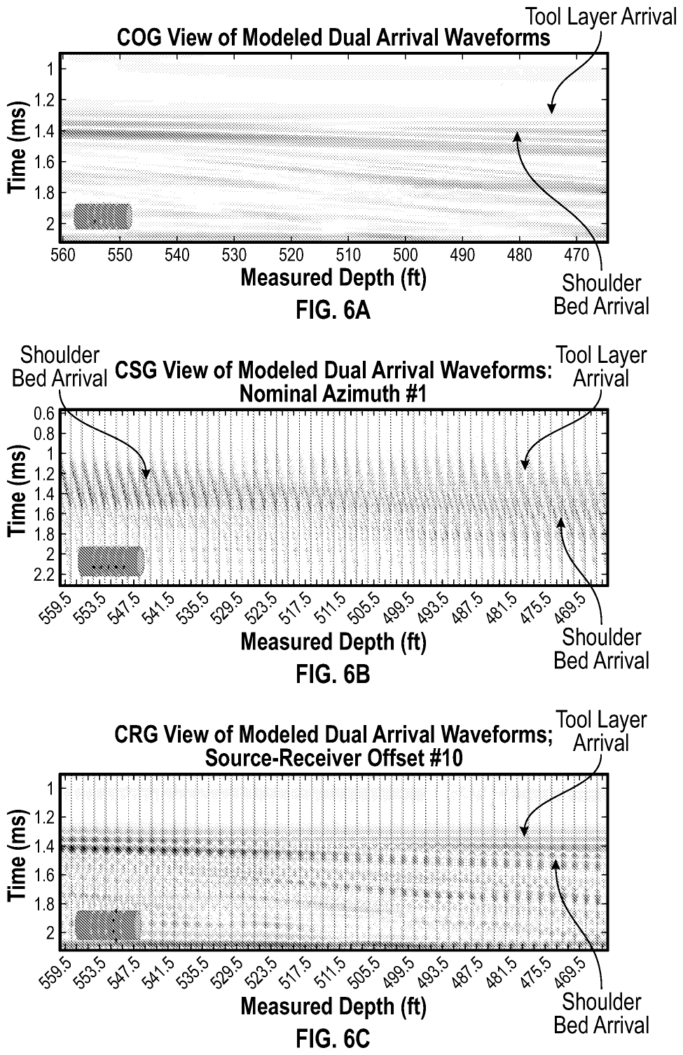

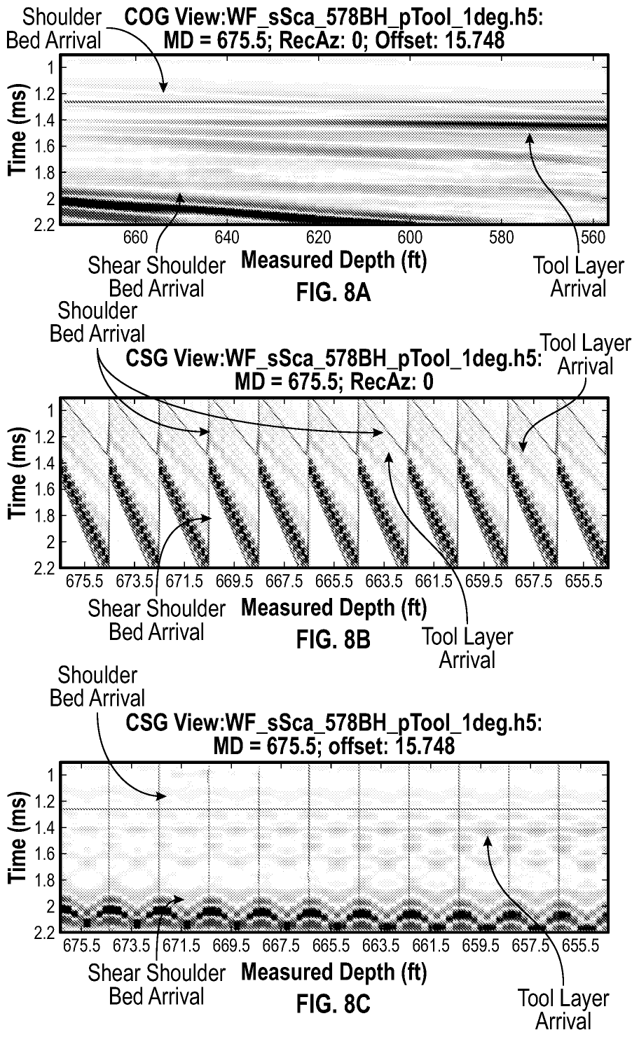

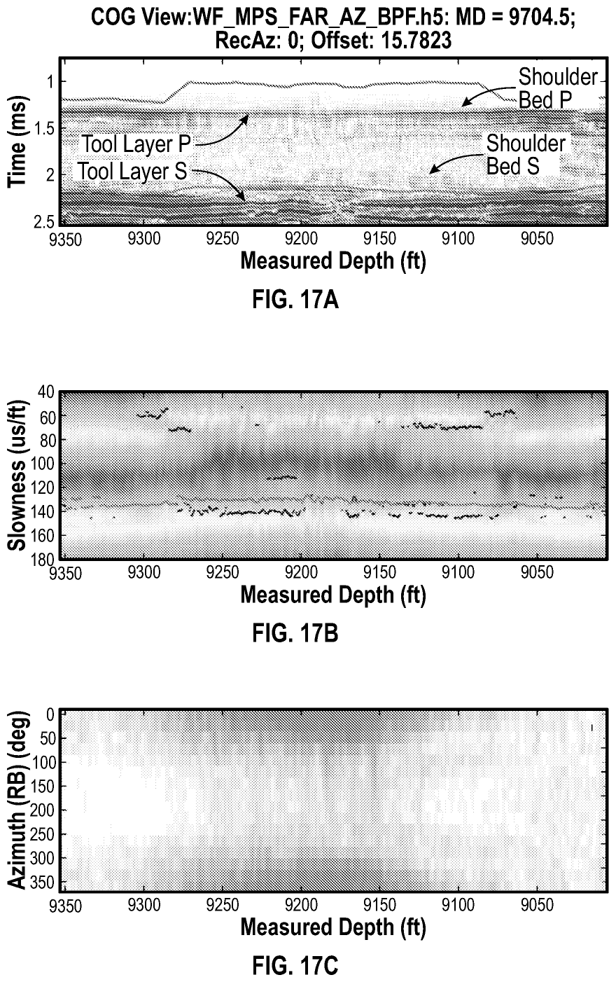

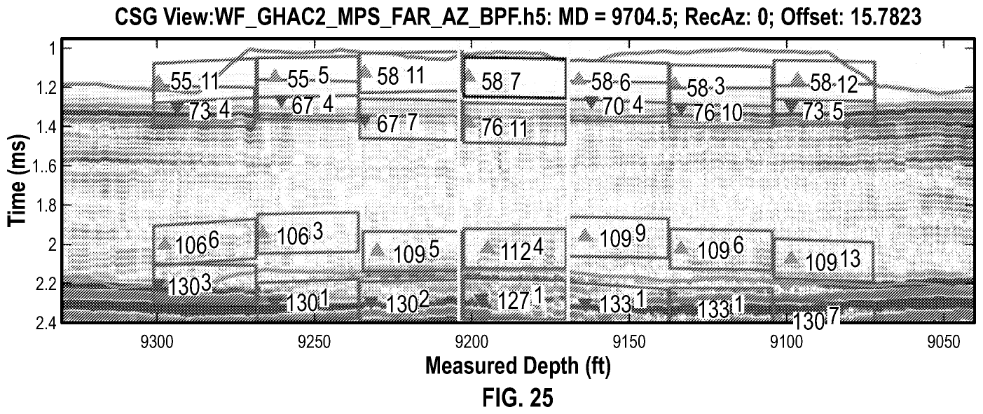

FIG. 4 depicts an example workflow. The Waveform Data, Preliminary Sonic Logs, Well Track Survey, and Bedding/Dip from BH Image are workflow inputs, while Log of Tool Layer and Shoulder Bed Slowness and Curtain Plot Slowness Along Well Track are workflow outputs. The other boxes are main workflow tasks. The workflow uses waveform measurements recorded using an acoustic logging tool with at least one source and an array of receiver sensors, as the primary input. FIGS. 6A through 6C and FIGS. 8A through 8C depict modeled waveforms processed using this workflow, and FIG. 17 and FIG. 25 depicts field data obtained using an acoustic logging tool. The workflow also takes as input the preliminary compressional (DTCO) and shear (DTSM) sonic logs which are typically computed on the acoustic logging tool during logging while drilling (LWD) operations or at wellsite during Wireline operations. These logs are used to help determine the range of values used for the tau-P transform's time variable τ.

The automated time pick workflow, outlined herein, produces a collection of tau-P peaks

$$( {τ}^{*} , {s}_{COG}^{*} , {s}_{CSG}^{*} , {s}_{CRG}^{*} )$$

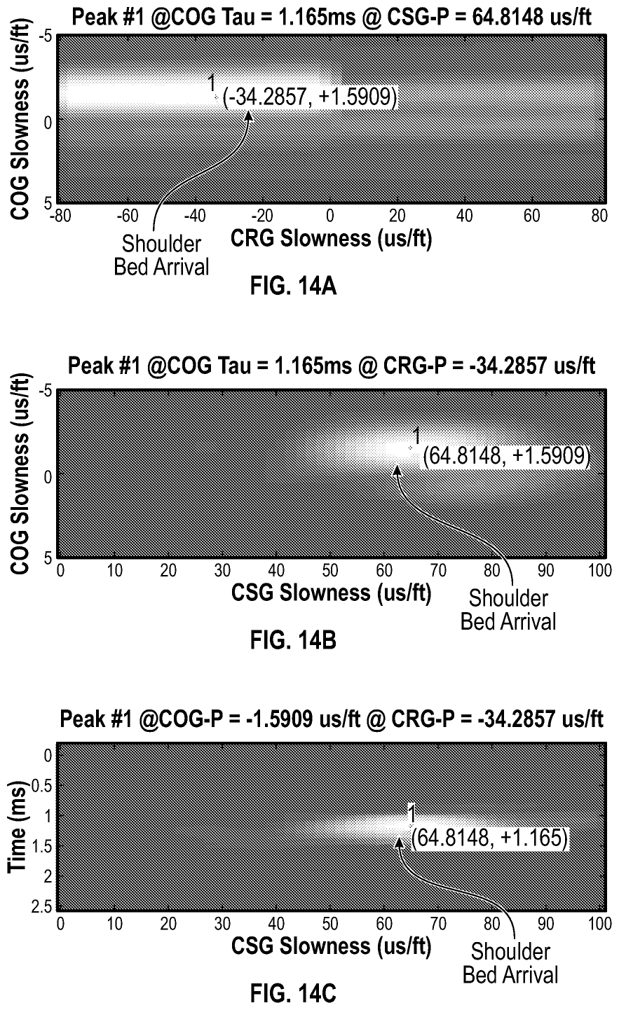

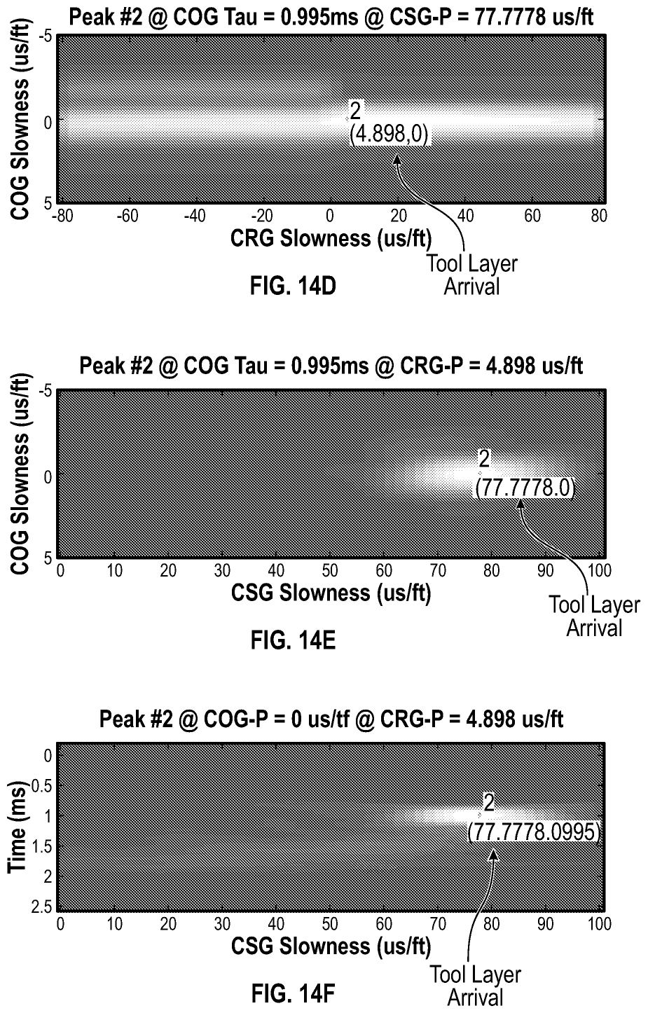

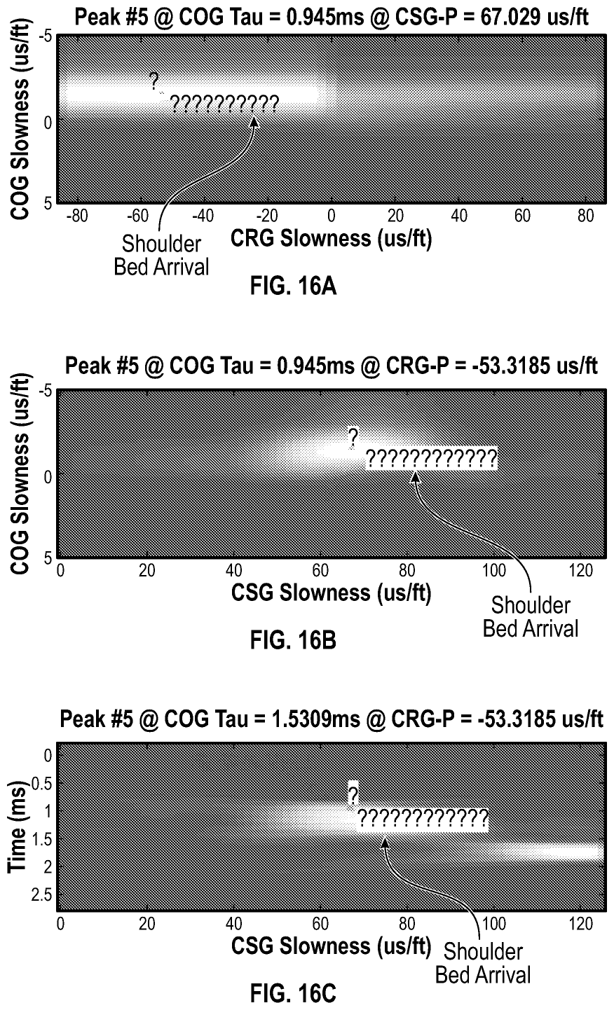

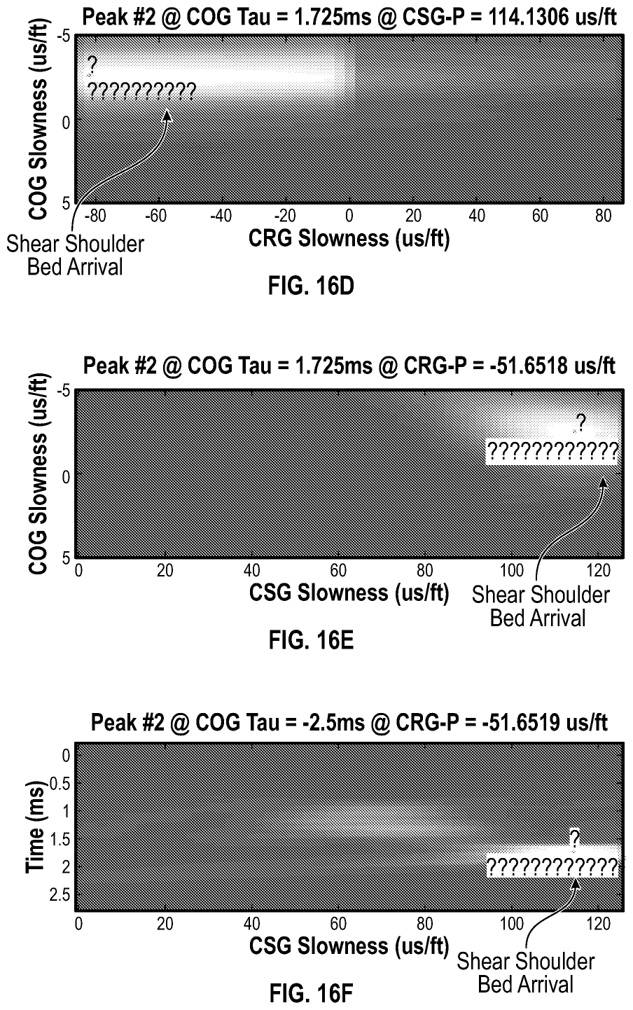

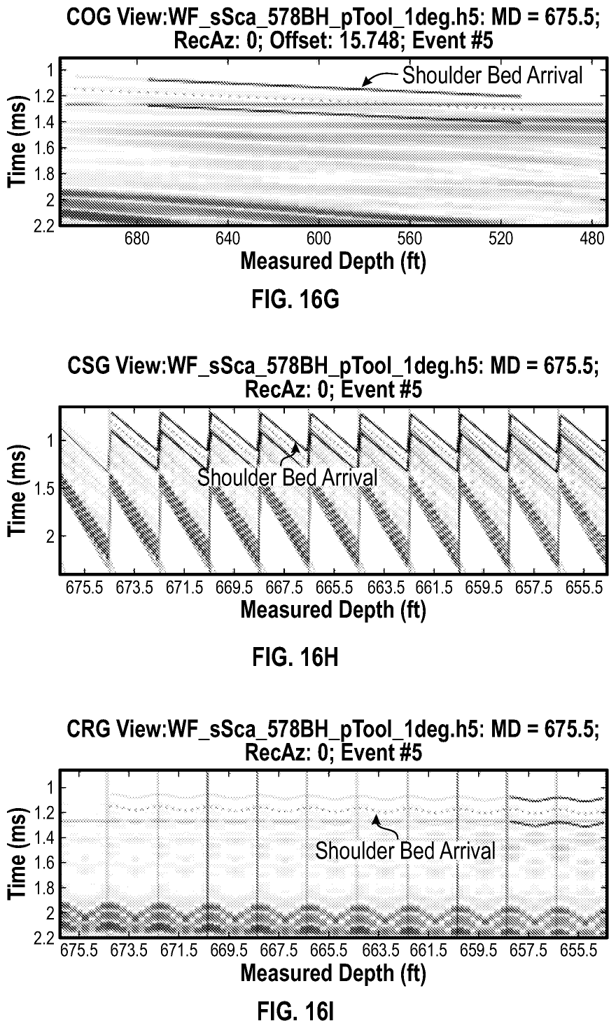

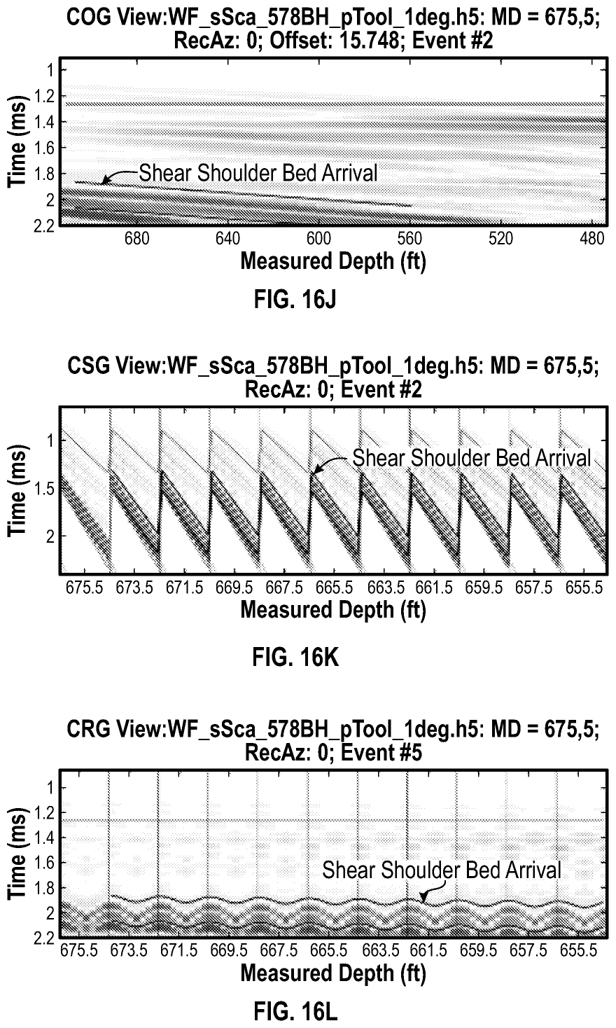

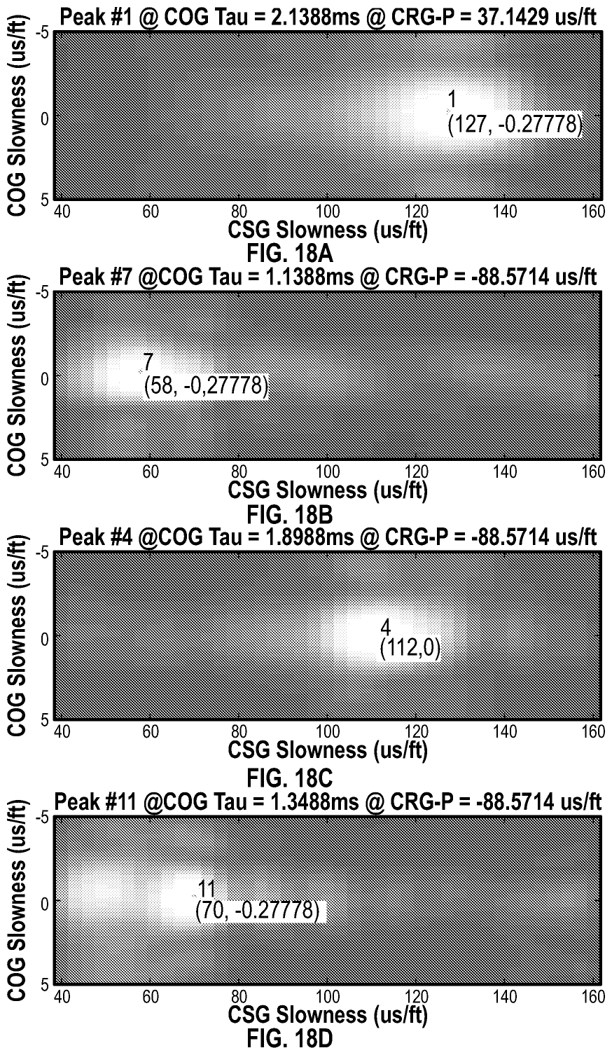

that characterize the dual arrival events present in the waveform measurements. These tau-P peaks are shown in FIGS. 14A through 14F and FIGS. 16A through 16L for modeled acoustic logging tool measurements and in FIGS. 18A through 18D for field acoustic logging tool measurements. Equation (6) shows how to compute a set of arrival times

$$t {t}_{j k}^{i}$$

(i.e., a time pick) for each dual arrival event from its corresponding tau-P peak values

$$( {τ}^{*} , {s}_{COG}^{*} , {s}_{CSG}^{*} , {s}_{CRG}^{*} ) .$$

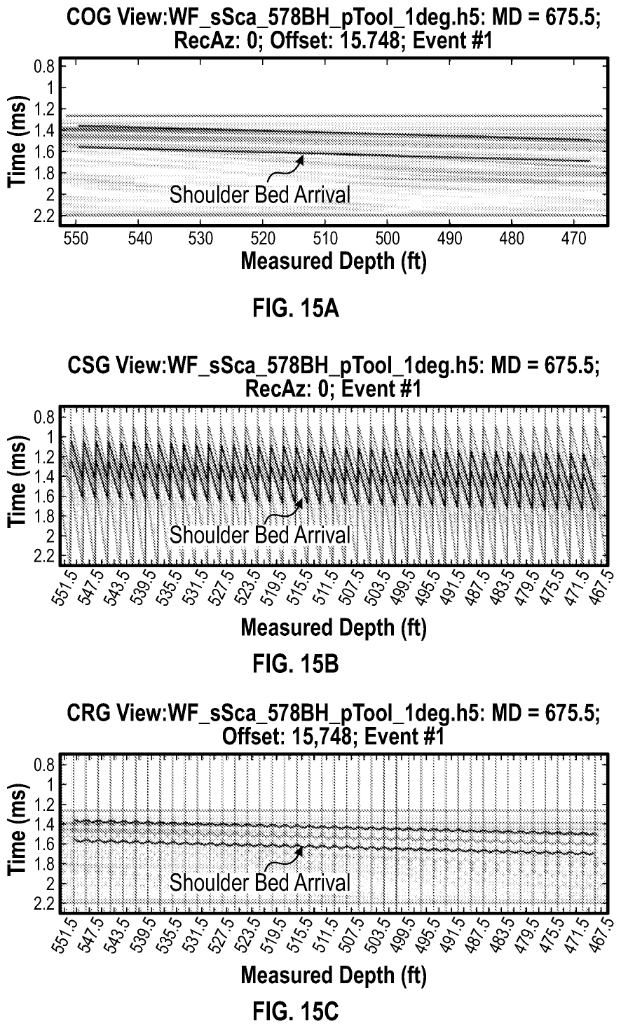

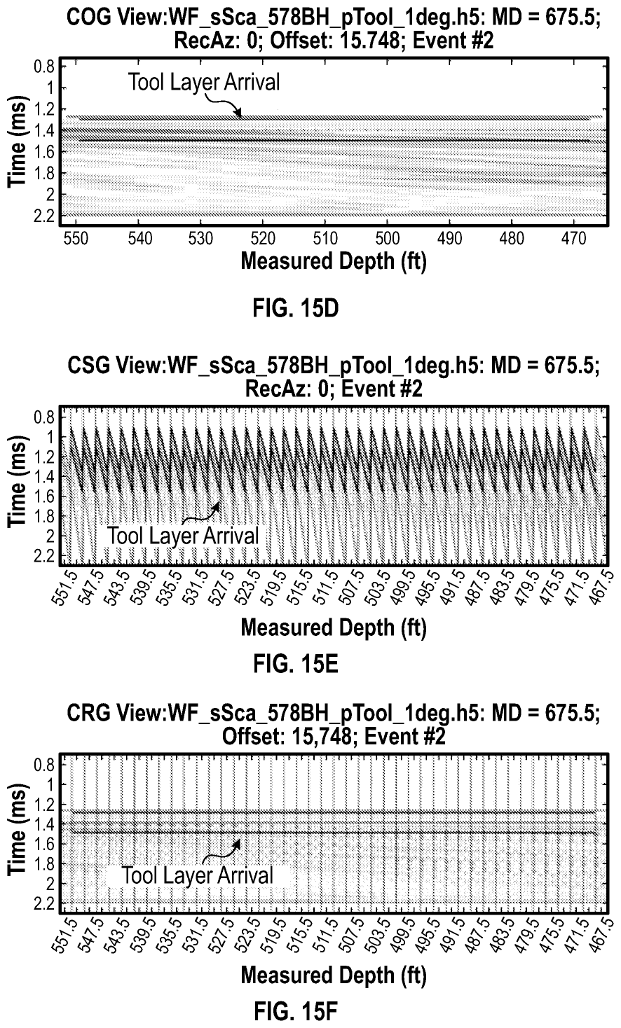

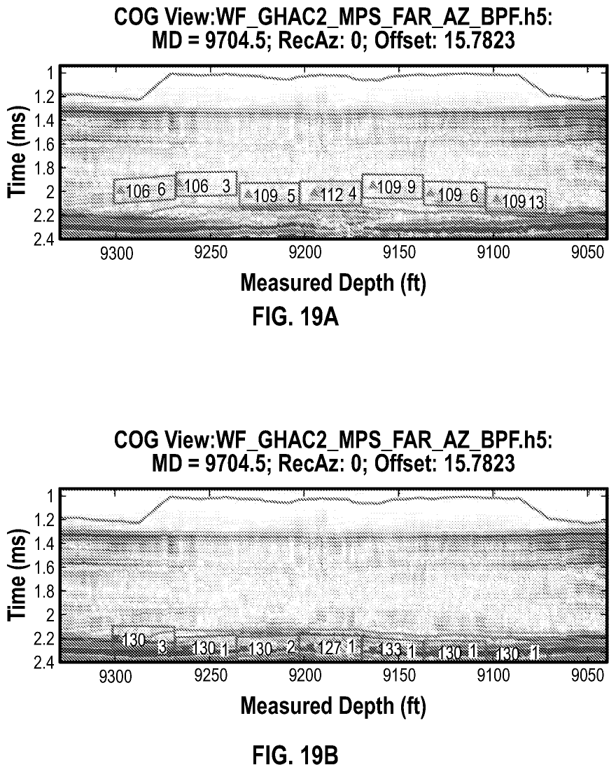

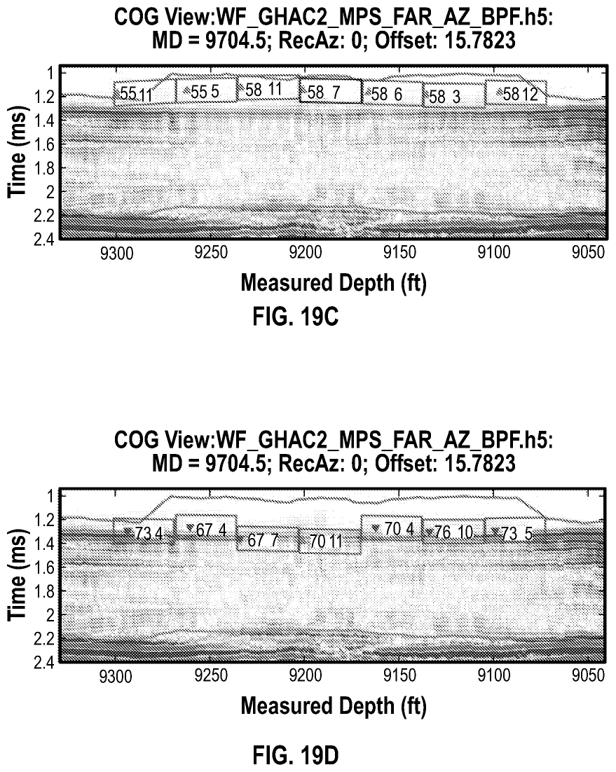

FIGS. 15A through 15F and FIGS. 16A through 16F show these time picks for modeled acoustic logging tool measurements, while FIGS. 19A through 19D show the time picks for the field acoustic logging tool waveforms. We note that when considering use of acoustic logging tool measurements, adjusting the automated time pick to handle the tool rotation is quite important, and we address this below.

The time pick classifier workflow, described in below, labels the tau-P peaks

$$( {τ}^{*} , {s}_{COG}^{*} , {s}_{CSG}^{*} , {s}_{CRG}^{*} )$$

as one of tool layer compressional, tool layer shear, shoulder bed compressional, or shoulder bed shear based on the value of the event's apparent slowness,

$${s}_{CSG}^{*} .$$

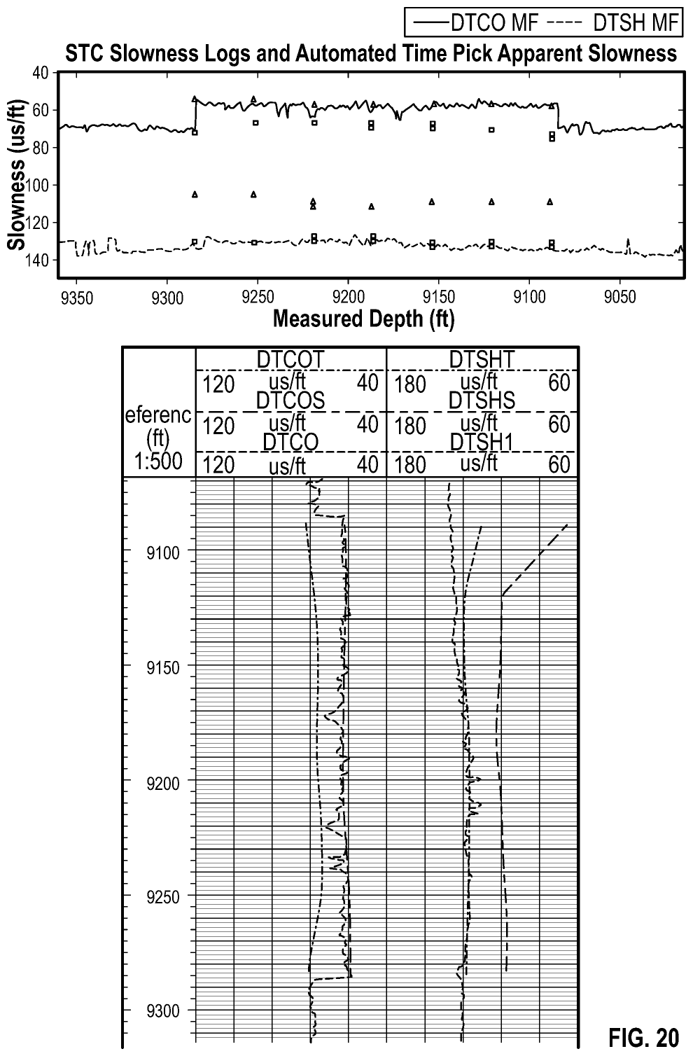

This classification produces a corresponding log display as shown in FIG. 20 which is very useful for formation evaluation purposes. This classification also produces estimates for the tool layer compressional slowness s_{p,tool} and tool layer shear slowness s_{s,tool} which are used to formulate the forward model in Equation (12) that is used by the ray tracing inversion.

The ray tracing inversion workflow, described in detail below, determines the raypath type of the shoulder bed arrival events labeled by the classifier workflow and inverts the corresponding event travel times

$$t {t}_{j , k}^{i}$$

for a local layered model of formation slowness. This automated raypath selection for shoulder bed events is exhibited using the checkmarks for modeled acoustic logging tool data in Table 1 (illustrated in the Appendix) and for field acoustic logging tool data in Table 3 (illustrated in the Appendix). The ray tracing inversion produces parameter estimates of a local layered formation model of slowness for the selected raypath type. These parameter estimates are exhibited for modeled acoustic logging tool data in Table 2 (illustrated in the Appendix) and for field acoustic logging tool data in Table 4 (illustrated in the Appendix).

The procedure for constructing the curtain section of slowness along the well track, described in below, begins first with a procedure for converting the local coordinates of the shoulder bed and acoustic logging tool used by the ray tracing inversion to the coordinates of the same along the well trajectory. Since the ray tracing inversion only maps the shoulder bed in 2D relative to the well track, here we incorporate the information available from the automated time pick

$${s}_{CRG}^{*}$$

that indicates whether the shoulder bed is above or below the well track. If the acoustic receiver array does not have azimuthal receiver sensors so that the estimate

$${s}_{CRG}^{*}$$

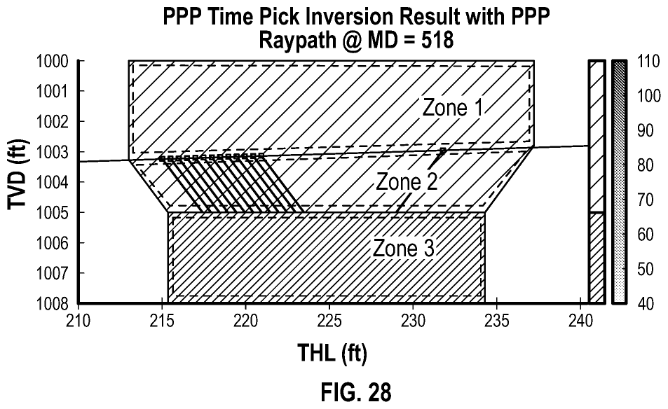

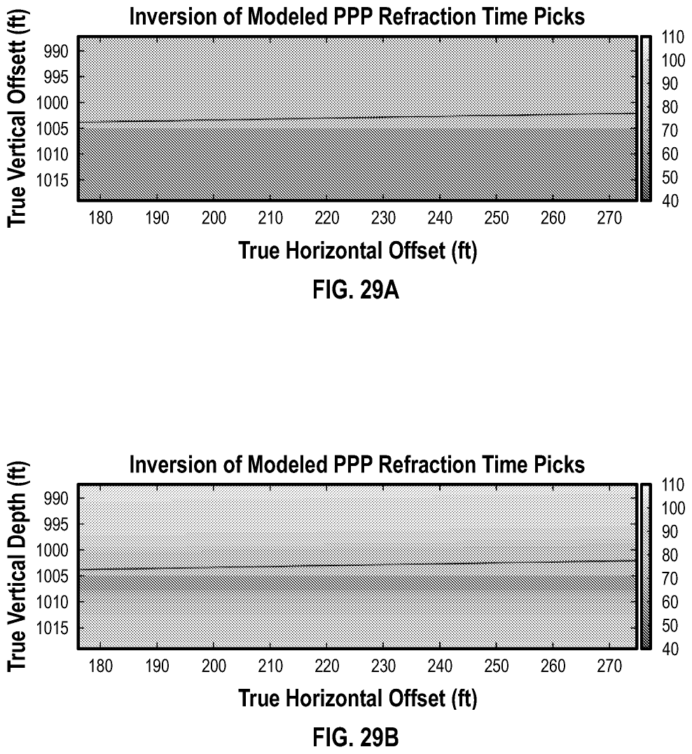

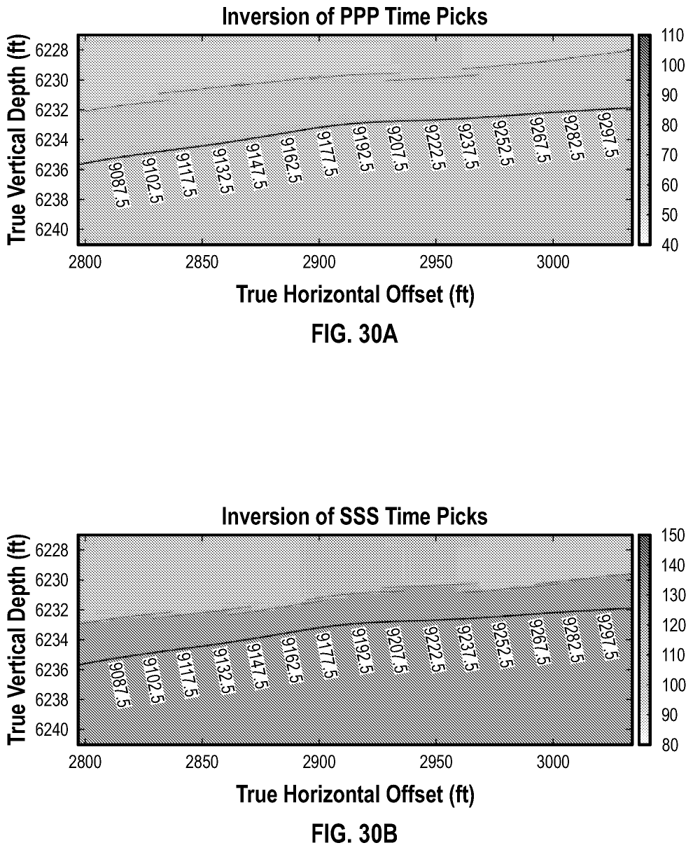

is not available, one can substitute azimuthal information from a density image such as in FIG. 17C or similar borehole image log. The outcome of this first procedure is shown, for example, in FIG. 28, where a curtain plot section of slowness is constructed for a single dual arrival PPP refraction event. A subsequent spatial averaging procedure then merges these local curtain sections for individual dual arrival events together into a complete curtain section of slowness along the length of the well trajectory as in FIGS. 29A and 29B and in FIGS. 30A and 30B.

An important focus of our physics modeling approach has been on understanding the details of how the shoulder bed and tool layer arrival events present themselves on receiver sensors mounted along the around the circumference of a sonic receiver array as a function of measured depth, source-receiver offset, and nominal azimuth. The main outcome of this physics modeling work has been to observe that shoulder bed and tool layer arrival events differ from one another in at least three respects:

The shoulder bed event arrival time varies with the distance to the shoulder bed, while the tool layer arrival time only varies with formation slowness; this distinction is most readily observed in the common offset (single sensor) (COG) view of the waveform measurements as a function of measured depth as highlighted in FIGS. 6A and 8A.

The shoulder bed arrival has a faster apparent slowness than the tool layer arrival; this distinction is most evident in the common shot or azimuth (CSG) view of the waveforms as a function of source-receiver offset as highlighted in FIGS. 6B and 8B.

The shoulder bed arrival exhibits a significant sinusoidal moveout in the common ring gather (CRG) domain as a function of nominal receiver azimuth as highlighted in FIGS. 6C and 8C.

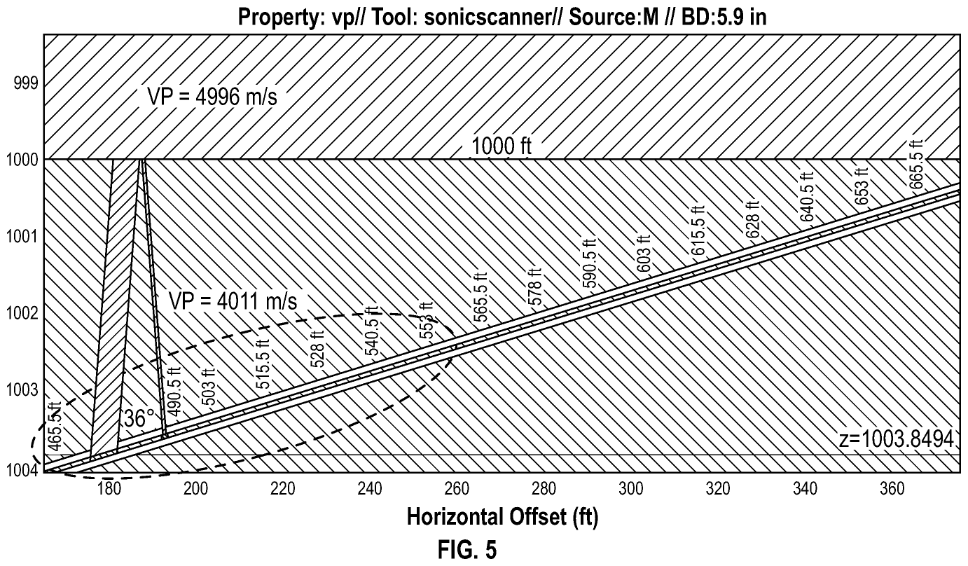

The first example of our physics modeling work is illustrated in FIG. 5 where we consider a two-layer model consisting of (a) a tool layer (with compressional and shear slownesses of 76 μs/ft and 136 μs/ft, respectively, and density 2500 kg/m3) along with (b) a nearby shoulder bed (with corresponding slownesses of 61 and 110 μs/ft and density 2450 kg/m3). The well track has a 1° dip relative to the horizontal shoulder bed boundary. The ray paths from source (the square around 192 ft) to shoulder bed boundary at 1000 ft vertical offset and then to each receiver sensor the square around 178-182 ft) illustrate a P-refraction. We performed similar ray tracings for P-reflections, S-refractions, and S-reflections.

We used a 3D finite difference simulation to forward model the acoustic logging tool measurements in a 5⅞″ diameter borehole at each measurement station along the well track in the measured depth zone marked by the red oval. The acoustic logging tool receiver array consists of 13 rings of 8 receiver sensors equally distributed around the circumference of the tool sonde. FIGS. 6A through 6C (as well as FIGS. 8A through 8C) display the forward modeled waveform measurements in a common offset (COG), common shot or azimuth (CSG), and common ring (CRG) gather views, respectively. FIGS. 6A and 8A show the waveforms recorded by a single receiver sensor of the acoustic logging tool receiver array as a function of measured depth along the well track. FIGS. 6B and 8B show the waveforms recorded by the 13 receiver sensors with a fixed nominal azimuth along one side of the acoustic logging tool receiver array. FIGS. 6C and 8C show the waveforms recorded by the 8 receiver sensors around the circumference of the acoustic logging tool receiver array at a fixed offset from the acoustic logging tool source.

Several physics observations can be derived from inspecting the waveforms from FIGS. 6A through 6C. The waveforms shown in FIGS. 6A through 6C were produced by 3D finite difference simulation for the measured depth zone, which is circled in FIG. 5. It can be observed in FIG. 6A that the arrival time of the shoulder bed arrival varies according to the distance from the tool sonde to the shoulder bed. It can also be observed that because the sonic tool is 3 to 4 feet from the shoulder bed, the time required for the shoulder bed arrival to propagate to the shoulder bed and back is long enough so that the shoulder bed arrival arrives after the tool layer arrival which propagates directly from the source to the receiver array within the tool layer. Further, close inspection of the waveforms in FIG. 6B show that the tool layer arrivals have a faster apparent slowness which is slower than the apparent slowness of the shoulder bed arrival. Finally, FIG. 6C indicates that the shoulder bed arrival does exhibit a significant sinusoidal moveout compared to that of the tool layer arrival. This sinusoidal moveout occurs because the shoulder bed arrival arrives first at the receiver sensors facing the shoulder bed and then later at the receiver sensors facing away from the shoulder bed.

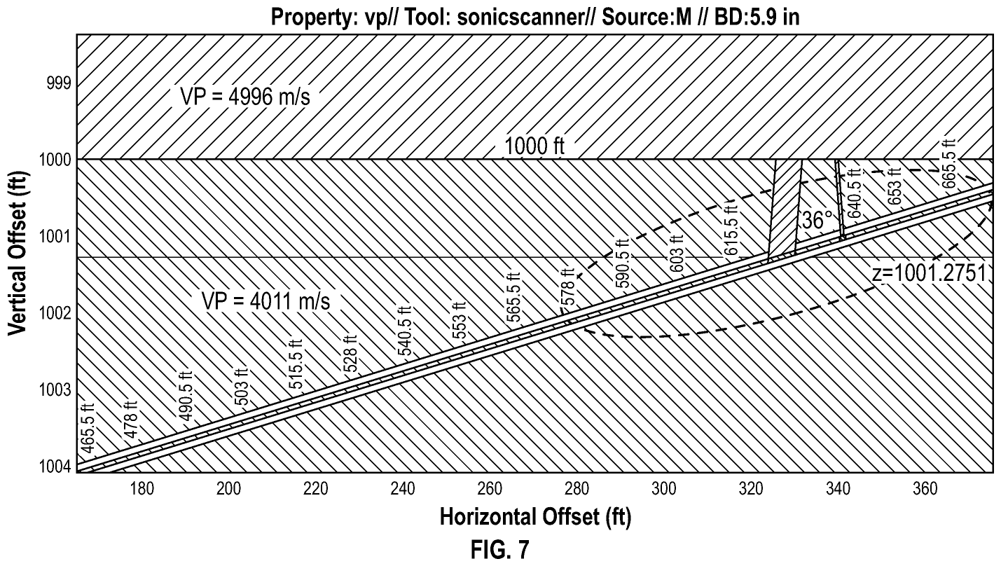

A second example of our physics modeling work is illustrated in FIG. 7 where we consider the same two-layer model and well track as shown in FIG. 5. Here we perform finite difference modeling for the measurement depth stations along the well track (circled) where the sonic tool is much closer to the shoulder bed boundary. The ray paths from source (the square around 338 ft) to shoulder bed boundary and then to each receiver sensor (the squares around 323-330 ft) illustrate a P-refraction. We performed similar ray tracings for P-reflections, S-refractions, and S-reflections.

Several further physics observations can be derived from inspecting the waveforms from FIGS. 8A through 8C. It can be observed in FIG. 8A that the arrival time of the shoulder bed arrival varies according to the distance from the tool sonde to the shoulder bed. It can also be observed that because the sonic tool is 1 to 2 feet from the shoulder bed, the time required for the compressional and shear shoulder bed arrivals to propagate to the shoulder bed and back is short enough and the propagation along the shoulder bed is rapid enough so that the shoulder bed arrival arrives before the corresponding tool layer arrival. Further, close inspection of the waveforms in FIG. 8B show that the tool layer arrivals have an apparent slowness which is slower than the apparent slowness of the shoulder bed arrivals. Finally, FIG. 8C indicates that the compressional and shear shoulder bed arrivals exhibit a significant sinusoidal moveout compared to that of the tool layer arrival. This sinusoidal moveout occurs because the shoulder bed arrival arrives first at the receiver sensors facing the shoulder bed and then later at the receiver sensors facing away from the shoulder bed. It is also noted that the curves shown in FIGS. 8A through 8C are the arrive time curves for the tool layer compressional and shear computed from the preliminary compressional (DTCO) and shear (DTSM) slowness logs.

The goal of the automated time pick is to detect and characterize the tool layer and shoulder bed arrivals present in the waveform measurements recorded by an acoustic logging tool. The automated time pick consists of (a) a series of tau-P transforms in the common offset (COG), common shot (CSG), and common ring (CRG) gather domains following the patterns observed during our physics modeling; (b) post-processing which includes coherent energy and coherence estimation techniques that improve the clarity of the tau-P processing results; and (c) peak finding methods for locating the local maxima from the results of steps (a) and (b) which correspond to the tool layer and shoulder bed arrival events in the recorded wavefield measurements.

The tau-P processing methods in the common offset (COG), common shot or azimuth (CSG), and common ring (CRG) gather domains are designed to separate and characterize the tool layer and shoulder bed arrivals and are described here. These three tau-P mappings both locate the event in the recorded wavefield measurements and characterize the arrival event in terms of (1) its slope and arrival time in the COG domain; (2) its apparent slowness in the CSG domain; and (3) whether the event is coming from above or below the well track according to its moveout in the CRG domain.

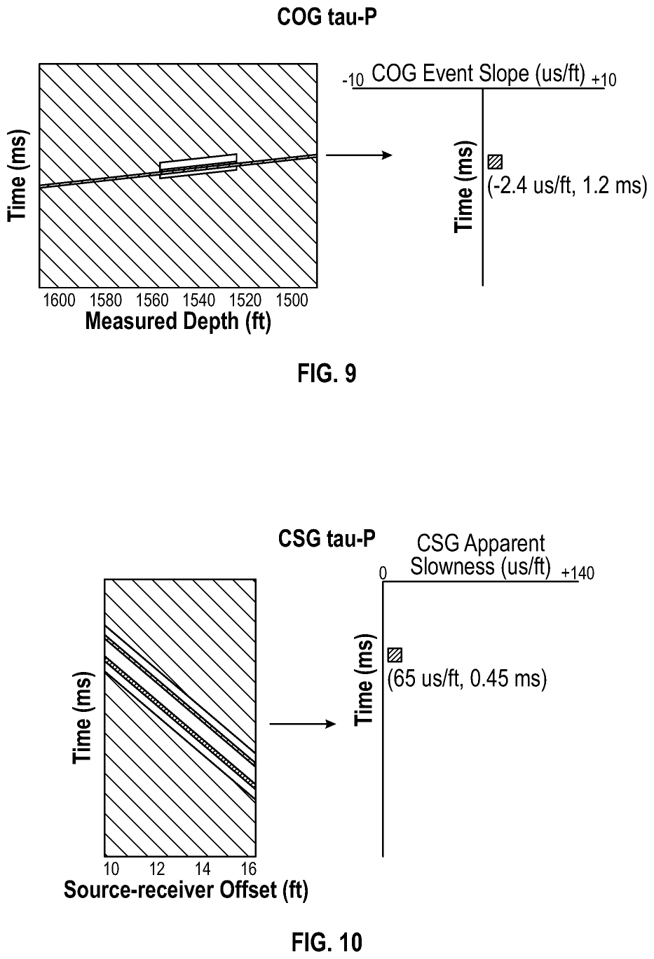

FIG. 9 provides an illustration of the COG tau-P processing which maps linear events in the recorded wavefield domain to points in the tau-P domain. The tau-P input waveforms wᵢ(t) are recorded at typically 15-60 consecutive measurement depth stations mdᵢ along the well track by a single receiver sensor of the acoustic receiver array. Equation (1) describes the COG tau-P processing where s_{COG} is the slope of the arrival event in the COG view of the waveform measurements and τ is the arrival time of the event at the midpoint of the measured depth interval, md_{M}. Peaks in the tau-P domain

$$( {τ}^{*} , {s}_{COG}^{*} )$$

correspond to the slope and arrival time of the arrival event and determine the line segment along which the arrival event is located. A subsequent event localization procedure is required to determine where along the line segment the event is located.

$${T}_{COG} ( τ , {s}_{COG} ) = {\sum }_{i} {w}_{i} ( τ + {s}_{COG} ( {md}_{i} - {md}_{M} ) ) \qquad ( 1 )$$

Default range of values used for s_{COG} is between −20 μs/ft and +20 μs/ft, while default range of values used for τ between

$$0.5 * \frac{DTCO * TR}{{10}^{3}} ms and 1.2 * \frac{DTSM * TR}{{10}^{3}} ms .$$

Here DTCO and DTSM are the preliminary compressional and shear slowness log estimates, respectively, TR is the transmitter-receiver spacing of the acoustic logging tool, and the two fractions convert the two slowness estimates to their corresponding arrival times in milliseconds.

FIG. 10 provides an illustration of the CSG tau-P processing which maps events in the common shot or azimuth gather domain to points in the tau-P domain. Tau-P peak coordinates correspond to the apparent slowness and arrival time of the event at the receiver sensor at the mid-point of the receiver array. The tau-P input waveforms wⱼ(t) are recorded at a single measurement depth station by receiver sensors with source-receiver offsets zⱼ along the side of the acoustic receiver array with a fixed nominal azimuth. Equation (2) describes the CSG tau-P processing where s_{CSG} is the apparent slowness of the arrival event and τ is the arrival time of the event at the midpoint of the receiver array, z_{M}. Peaks in the tau-P domain

$$( {τ}^{*} , {s}_{CSG}^{*} )$$

correspond to the apparent slowness and arrival time of the arrival at the mid-point of the receiver array.

$${T}_{CSG} ( τ , {s}_{CSG} ) = {\sum }_{j} {w}_{j} ( τ + {s}_{CSG} ( {z}_{j} - {z}_{M} ) ) \qquad ( 2 )$$

Default range of values used for s_{CSG} is between 40 μs/ft and 125 μs/ft, while again the default range of values used for τ between

$$0.5 * \frac{DTCO * TR}{{10}^{3}} ms and 1.2 * \frac{DTSM * TR}{{10}^{3}} ms .$$

Here DTCO and DTSM are the preliminary compressional and shear slowness log estimates, respectively, TR is the transmitter-receiver spacing of the acoustic logging tool, and the two fractions convert the two slowness estimates to their corresponding arrival times.

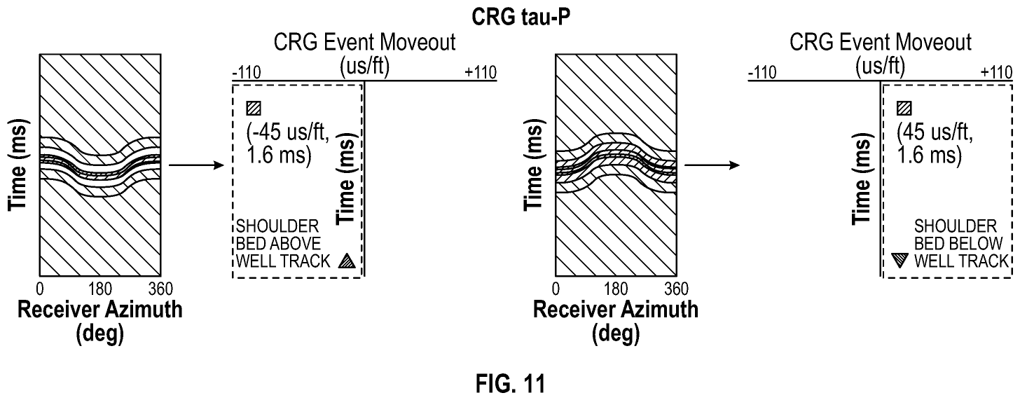

FIG. 11 provides an illustration of the CRG tau-P processing which maps events in the common ring gather domain to points in the tau-P domain. Tau-P peak coordinates correspond to the amplitude of the event's sinusoidal moveout as a function of nominal receiver azimuth and arrival time of the event. Negative CRG tau values correspond to when the shoulder bed is above the well track, whereas positive CRG tau values correspond to when the shoulder bed is below the well track.

The tau-P input waveforms wₖ(t) are recorded at a single measurement depth station by a single ring of receiver sensors with receiver azimuths αₖ with a fixed source-receiver offset. In Equation (3), αₖ is the receiver azimuth measured from the top of the tool sonde, and rₜₒₒₗ is the tool sonde radius, so rₜₒₒₗ cos(αₖ) is the vertical offset of the kth receiver sensor relative to the center axis of the tool sonde. The CRG slowness estimate s_{CRG} thus represents the amplitude of the sinusoidal moveout as a function of nominal azimuth around the circumference of the tool sonde and can take positive or negative values, depending upon whether the shoulder bed arrival is coming from a shoulder bed below or above the well track, respectively.

$${T}_{CRG} ( τ , {s}_{CRG} ) = {\sum }_{k} {w}_{k} ( τ + {s}_{CRG} ( {r}_{tool} cos ( {α}_{k} ) ) ) \qquad ( 3 )$$

Peaks in the tau-P domain

$$( {τ}^{*} , {s}_{CRG}^{*} )$$

correspond to the arrival time of the event τ* at the center axis of the tool sonde, and

$${s}_{CRG}^{*} < 0$$

means that the arrival event corresponds to a shoulder bed above the well track, while

$${s}_{CRG}^{*} > 0$$

means that the arrival event corresponds to a shoulder bed below the well track. The sign of

$${s}_{CRG}^{*}$$

will be subsequently used in various log and waveform displays as well as in the ray tracing inversion described below.

Default range of values used for s_{CRG} is between −110 μs/ft and +110 μs/ft, while again the default range of values used for τ between

$$0.5 * \frac{DTCO * TR}{{10}^{3}} ms and 1.2 * \frac{DTSM * TR}{{10}^{3}} ms .$$

Here DTCO and DTSM are the preliminary compressional and shear slowness log estimates, respectively, TR is the transmitter-receiver spacing of the acoustic logging tool, and the two fractions convert the two slowness estimates to their corresponding arrival times.

While the tau-P processing methods in the common offset (COG), common shot or azimuth (CSG), and common ring (CRG) gather domains are designed to separate and characterize the tool layer and shoulder bed arrivals, here we illustrate important post-processing methods which are critical for improving the clarity of the tau-P peaks

$$( {τ}^{*} , {s}_{COG}^{*} , {s}_{CSG}^{*} , {s}_{CRG}^{*} ) .$$

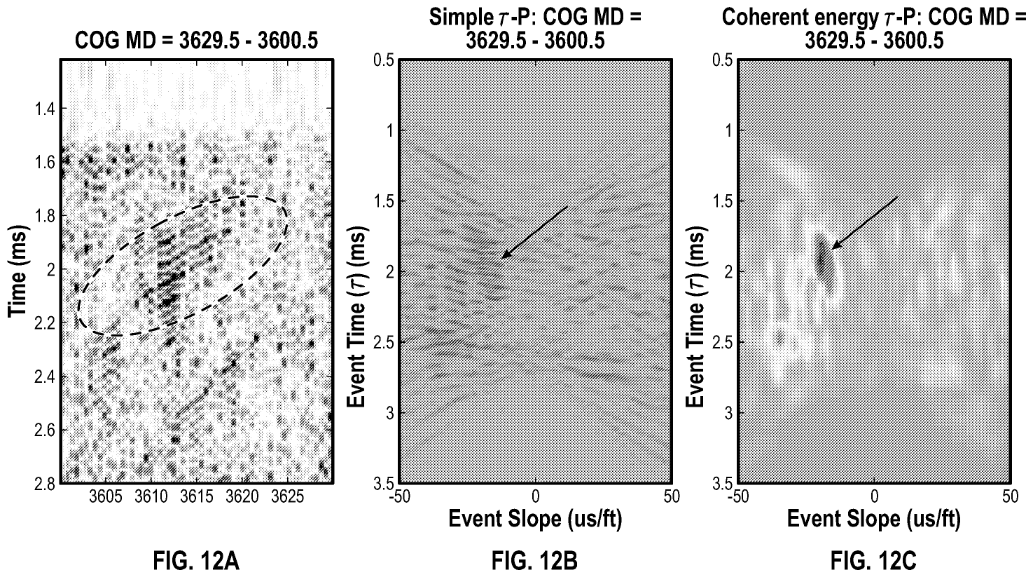

When processing waveform measurements, undulations in waveform arrival events often lead to undulations in the corresponding tau-P peaks as illustrated in FIGS. 12A and 12C. We observe in FIG. 12A a reflected arrival event (circled) sloping from lower left to upper right near recording time 1.9 ms. FIG. 12B shows the corresponding COG tau-P processing result where the corresponding peak signature at event slope

$$\begin{matrix}{E}_{i} ( τ , {s}_{COG} ) = {\int }_{- \frac{Δ}{2}}^{\frac{Δ}{2}} {\sum }_{j} {w}_{i}^{2} ( t - τ - {s}_{COG} ( {md}_{i} - {md}_{M} ) ) dt \\ = {{T}_{COG}^{w 2} ( τ , {s}_{COG} )}^{2} * {boxcar}_{Δ} ( τ )\end{matrix} \qquad ( 5 )$$

$$coh ( τ , {s}_{COG} ) = \sqrt{\frac{{E}_{c} ( τ , {s}_{COG} )}{{n}_{md} {E}_{i} ( τ , {s}_{COG} )}}$$

and τ*≈1.9 ms indicated by the violet arrow exhibits the same undulation signature. These undulations in the peak signature arise because the corresponding COG tau-P processing from Equation (1) is making line averages of the waveforms along the corresponding undulations of the reflected arrival event.

To address this issue for this example, we employ a coherent energy estimation shown in the first line of Equation (4) that first stacks the wavefield as a function of measured depth according to COG slowness s_{COG} and then estimates the coherent energy in a time window of duration Δ=0.2 ms. This coherent energy technique is adapted from corresponding slowness time coherence methods. This coherent energy processing result is shown in FIG. 12C where the undulations have been largely removed and the peak signature corresponding to the reflection arrival highlighted with the white arrow is much more evident.

$${s}_{COG}^{*} = - 20 µs / ft$$

The second line of Equation (4) highlights the fact that the coherent energy estimation E_{c}(τ,s_{COG}) can be written as a COG tau-P transform T_{COG} (τ,s_{COG}) from Equation (1) convolved with a boxcar function of duration Δ. This is a very helpful observation, as it says we can use this convolution operation as a post-processing when combining the CSG, COG, CRG tau-P processing from Equations (1)-(3) together as described in the combined Tau-P workflow described in the next section.

Similar post processing methods to improve the clarity of the tau-P peaks can be used, including a coherence estimate coh(τ,s_{COG}) which is computed by normalizing E_{c}(τ,s_{COG}) according to the total energy estimate Eᵢ(τ,s_{COG}) as in Equation 5.

$$\begin{matrix}{E}_{c} ( τ , {s}_{COG} ) = {\int }_{- \frac{Δ}{2}}^{\frac{Δ}{2}} {( {\sum }_{j} {w}_{i} ( t - τ - {s}_{COG} ( {md}_{i} - {md}_{M} ) ) )}^{2} dt \\ = {T}_{COG}^{2} ( τ , {s}_{COG} ) * {boxcar}_{Δ} ( τ )\end{matrix} \qquad ( 4 )$$

Here n_{md} is the number of measured depth stations in the common offset gather.

$${T}_{COG}^{w 2}$$

refers to the same COG tau-P operation as in Equation (1) but applied to the squared waveforms

$${w}_{i}^{2} ( t ) .$$

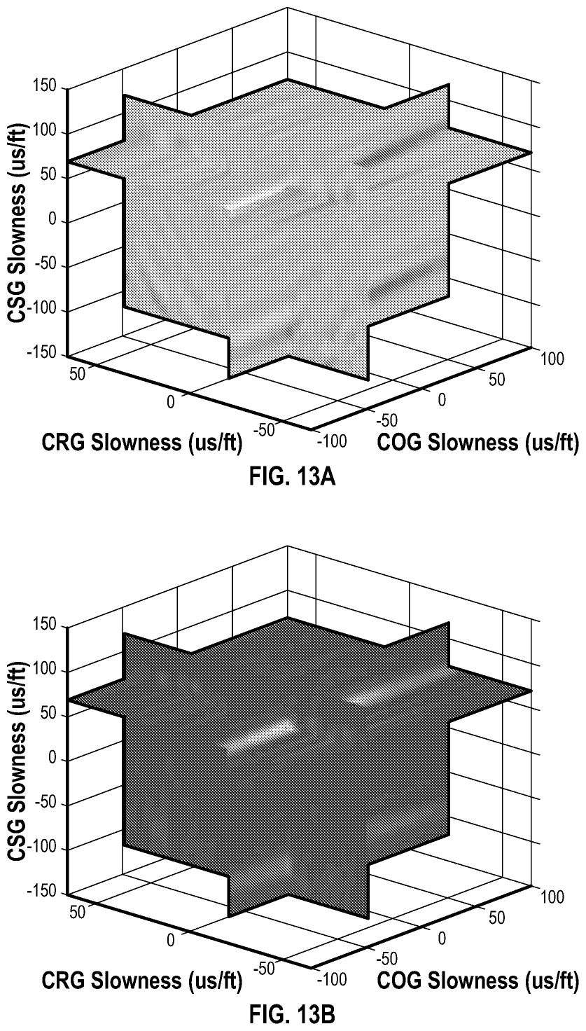

FIGS. 13A and 13B illustrate the effectiveness of this boxcar convolution operation for improving the clarity of the combined CSG, COG, CRG tau-P processing as described in step 6 of the combined Tau-P workflow described in the next section. FIG. 13A shows a 3D slice of the 4D CSG-COG-CRG-i processing for τ≈1.9 ms for the waveforms shown in FIG. 12A. We observe the undulations in the tau-P peak signatures which makes locating and characterizing the arrival event very difficult. However, FIG. 13B shows the same 3D slice obtained after convolving the 4D CSG-COG-CRG-τ in time variable τ with the box car function. We again observe significant improvements in the peak clarity around

$$( {τ}^{*} , {s}_{COG}^{*} , {s}_{CSG}^{*} , {s}_{CRG}^{*} )$$

which is critical.

The overall automated time pick workflow can be summarized as follows:
1. Compute tau-P in CSG domain for every MD location and each nominal azimuth according to Equation 2. Concatenate results into a 4D cube. The cube is parameterized as tau-CSG×p-CSG×nominal receiver azimuth×MD.
2. Permute cube indices to be tau-CSG×nominal receiver azimuth×MD×p-CSG.
3. Compute CRG tau-P for each MD×p-CSG slice according to Equation 3. This results in tau-CRG×p-CRG×MD×p-CSG.
4. Permute cube indices to be tau-CRG×MD×p-CRG×p-CSG. Store this cube for the event localization procedure in step 8.
5. Compute COG tau-P for each p-CRG×p-CSG slice according to Equation 1. This results in tau-COG×p-COG×p-CRG×p-CSG.
6. Convolve the 4D cube as a function of tau-COG with a 1D boxcar function of duration Δ=0.2 ms following the pattern of Equation 4.

To help the time pick search for high energy coherent events in the waveform measurements the following complete the automated time pick procedure.
7. Use a local median filter on the 4D tau-P cube to reduce noise and sharpen peaks.
8. Find and sort the local maxima in 4D cube.
9. For selected local max, employ the event localization procedure for projected waveforms from the tau-CRG×MD×p-CRG×p-CSG cube to find start and end MD of the arrival event in the common offset gather domain.

The output of the automated time pick procedure includes: (a) a list of peak coordinates

$$( {τ}^{*} , {s}_{COG}^{*} , {s}_{CSG}^{*} , {s}_{CRG}^{*} )$$

as well as (b) the corresponding arrival event travel times

$$\{ {tt}_{j , k}^{i} \}$$

where j, k index the source-receiver offsets and nominal receiver azimuths of the acoustic receiver array, respectively, and i indexes the measured depth stations where the wavefield was recorded. These travel times

$$\{ {tt}_{j , k}^{i} \}$$

can be computed from the tau-P peak coordinates according to Equation 6.

$${ll}_{j , k}^{i} = {τ}^{*} + {s}_{CSG}^{*} ( {z}_{j} - {z}_{M} ) + {s}_{CSG}^{*} {r}_{tool} cos ( {α}_{k} ) + {s}_{COG}^{*} ( {md}_{i} - {md}_{M} ) \qquad ( 6 )$$

Now we consider some additional important details to consider when executing the automated time pick when the tool is rotating. When executing a general tau-P processing step, the input waveforms wₗ(t) are defined on a time domain grid tₘᵢₙ, tₘᵢₙ+Δt, tₘᵢₙ+2Δt, . . . , tₘₐₓ and on a spatial grid xᵢ which has values on the grid x=xₘᵢₙ, xₘᵢₙ+Δx, xₘᵢₙ+²Δx, . . . , xₘₐₓ.

The tau-P transform T(τ,s) of the input waveforms wᵢ(t) will have slowness defined on a grid s=sₘᵢₙ, sₘᵢₙ+Δs, sₘᵢₙ+2Δs, . . . , sₘₐₓ. Further, a common practice to define the output τ grid is to define τₘᵢₙ, τₘᵢₙ+Δt, τₘᵢₙ+2Δt, . . . , τₘₐₓ that uses the same time sampling spacing Δt as in the input waveforms wᵢ(t) and to define τₘᵢₙ and τₘₐₓ following Equation (7).

$${τ}_{min} = {t}_{min} - max ( {s}^{′} \cdot x ) \qquad ( 7 )$$

$${τ}_{max} = {t}_{max} - min ( {s}^{′} \cdot x )$$

When conducting a CSG or COG tau-P processing as in steps 1 and 5 listed above, the spatial grid×where the input waveforms are defined will always be fixed, so that the values of τₘᵢₙ and τₘₐₓ and thus the tau-P output grid will also be fixed. For the CSG tau-P processing, the spatial grid is given by the source-receiver offsets of the acoustic logging tool. For the COG tau-P processing, the spatial grid will be given by the distance between the measurement depth stations which will often be fixed at 0.5 ft.

However, when conducting the CRG tau-P processing as in step 3 of the automated time pick workflow listed above, the spatial grid is given by the spatial locations of the receiver sensors around the circumference of the tool sonde xₖ=rₜₒₒₗ cos(αₖ) which will depend on the relative tool orientation. Thus, the output r grid used for the CRG tau-P transform T_{CRG} (τ,s_{CRG}) defined in Equation 7 will also depend on the tool orientation. This tool orientation dependence would greatly complicate the subsequent COG tau-P processing in step 5. To address this issue, we employ a fixed output time grid for the CRG tau-P transform T_{CRG}(τ,s_{CRG}) as in Equation 8 that only depends on the acoustic logging tool radius rₜₒₒₗ.

$${τ}_{CRG , min} = {t}_{min} - max ( {s}^{′} \cdot {r}_{tool} ) = {t}_{min} - {s}_{max} * {r}_{tool} \qquad ( 8 )$$

$${τ}_{CRG , max} = {t}_{max} - min ( {s}^{′} \cdot {r}_{tool} ) = {t}_{max} - {s}_{min} * {r}_{tool}$$

This modification is helpful when the waveforms are recorded using a Wireline acoustic logging tool where the tool can often rotate 360° while logging a few hundred feet of measured depth. This modification is critical when utilizing a logging-while-drilling (LWD) tool where the tool rotates 360° every few seconds.

The automated time pick procedure has been tested on several modeled and field datasets. FIGS. 14A through 14F show two-dimensional (2D) slices from the 4D tau-P array produced using the automated time pick workflow for the waveforms with shoulder bed and tool layer arrivals described in FIG. 5 and FIGS. 6A through 6C. The three panels on the left side of the figure show the COG-CRG slowness, COG-CSG slowness, and Time-CSG Slowness slices through the peak

$$( {τ}^{*} , {s}_{COG}^{*} , {s}_{CSG}^{*} , {s}_{CRG}^{*} )$$

corresponding to the shoulder bed arrival, while the three panels on the right side of the figure show the peak

$$( {τ}^{*} , {s}_{COG}^{*} , {s}_{CSG}^{*} , {s}_{CRG}^{*} )$$

corresponding to the tool layer arrival event. Each panel shows two of the peak coordinates in the 2D slice, and the title of each panel gives the other two peak coordinate values. We observe that the tau-P processing is clearly separating the peaks corresponding to the shoulder bed and tool layer arrivals. We also observe that the post-processing described in step 6 of the automated workflow leads to a high level of clarity in the 4D array for identifying the tool layer and shoulder bed arrival events.

FIGS. 15A through 15F show the automated time picks

$${tt}_{j , k}^{i}$$

computed from Equation 6 and overlaid on the waveform measurements corresponding to the tau-P coordinates

$$( {τ}^{*} , {s}_{COG}^{*} , {s}_{CSG}^{*} , {s}_{CRG}^{*} )$$

identified in FIGS. 14A through 14F. FIGS. 14A through 14C show the time picks for the shoulder bed arrival in the common offset (COG), common shot (CSG), and common ring (CRG) gather domains, while FIGS. 14D through 14F show the time picks for the tool layer arrival. The time windows shown as the black waveform overlay are computed as

$${tt}_{j , k}^{i} - \frac{Δ}{2} and {t}_{j , k}^{i} + \frac{Δ}{2}$$

where Δ is the window length used for the boxcar function in step 6 of the automated time pick workflow. We observe that the time pick waveform overlay is very informative for identifying the various arrival events.

FIGS. 16A through 16F show 2D slices from the 4D tau-P array produced for the waveforms with shoulder bed and tool layer arrivals described in FIG. 7 and FIGS. 8A through 8C, while FIGS. 16G through 16L show the corresponding time pick event overlay. FIGS. 16A through 16C show the COG-CRG slowness, COG-CSG slowness, and Time-CSG Slowness slices through the peak

$$( {τ}^{*} , {s}_{COG}^{*} , {s}_{CSG}^{*} , {s}_{CRG}^{*} )$$

corresponding to the shoulder bed P arrival, while FIGS. 16D through 16F show the corresponding 2D slices for the shoulder bed S arrival. As in FIG. 14, each panel shows two of the peak coordinates in the 2D slice, and the title of each panel gives the other two peak coordinate values. We again observe that the tau-P processing result produced by the automated workflow is clearly separating the peaks corresponding to the two shoulder bed refractions. For purposes of brevity, we have omitted the set of slices that correspond to the tool layer arrival, though the automated processing separates and identifies the tool layer arrival in a very similar and effective fashion.

FIGS. 16G through 16L show the automated time picks

$$t {t}_{j , k}^{i}$$

computed from Equation 6 and overlaid on the waveform measurements corresponding to the tau-P coordinates

$$( {τ}^{*} , {s}_{COG}^{*} , {s}_{CSG}^{*} , {s}_{CRG}^{*} )$$

identified in FIGS. 16A through 16F. FIGS. 16G through 16I show the time picks for the shoulder bed P arrival in the common offset (COG), common shot (CSG), and common ring (CRG) gather domains, while FIGS. 16J through 16L show the time picks for the shoulder bed S arrival. The time windows shown as the black waveform overlay are computed as

$${tt}_{j , k}^{i} - \frac{Δ}{2} and {tt}_{j , k}^{i} + \frac{Δ}{2} .$$

Again, the time pick waveform overlay is very informative for identifying the various arrival events.

FIGS. 17A through 17C introduce a field data example where the automated time pick is used to identify and characterize the tool layer and shoulder bed arrivals along a highly deviated well in a limestone layer lying between two faster dolomite layers. FIG. 17A shows a common offset (COG) gather view of Sonic Scanner waveforms where the tool layer and shoulder bed arrivals are marked. The tool layer arrivals appear with mostly horizontal waveform signatures in the COG waveform view, while the shoulder bed P and S arrivals have an arcing signature which is received before the corresponding tool layer arrivals. We note the preliminary arrival time estimates for the tool layer compressional and shear arrival times that are computed from the compressional (DTCO) and shear (DTSM) slowness logs, respectively. FIG. 17B shows the slowness time coherence (STC) image log where both dual arrival P and S signatures are present. FIG. 17C is an azimuthal density image log indicating that a denser layer (the dolomite) is above the well track at 0° relative bearing through this section of the well.

FIGS. 18A through 18D show 2D slices from the 4D tau-P array produced for the waveforms shown in FIG. 17A, while FIGS. 19A through 19D show the corresponding time pick event overlay. The four 2D slices shown in FIGS. 18A through 18D are all COG-CSG slices for arrival events #1, 4, 7, and 11, which are identified in the 4th measured depth interval near 9180 ft MD in FIGS. 19A through 19D. These same four events are more clearly marked in FIG. 25. As with the modeled data examples, we observe that the tau-P processing is clearly separating the peaks corresponding to the shoulder bed and tool layer arrivals, because these arrival events have distinct values for CSG apparent slowness. We also observe that the post-processing described in step 6 of the automated workflow leads to a high level of clarity in the 4D tau-P array for identifying the tool layer and shoulder bed arrival events.

FIGS. 19A through 19D show the waveform overlay produced by the automated time pick workflow for the Sonic Scanner waveform measurements shown in FIG. 17A. The shoulder bed S and P arrivals are shown in FIGS. 19A and 19C, respectively, while the tool layer S and P arrivals are shown in FIGS. 19B and 19D, respectively. The arrival events include an estimate of apparent slowness and an up or down arrow indicating whether the shoulder bed is above or below the well track. The arrival events are marked with boxes computed

$${tt}_{j , k}^{i} - \frac{Δ}{2} and {tt}_{j , k}^{i} + \frac{Δ}{2} .$$

These boxes also include a number indicating the event's CSG slowness

$$( {s}_{CSG}^{*} )$$

and an up or down arrow indicating whether, for example, the shoulder bed is above or below the well track. The arrow points up if the CRG slowness is negative

$$( {s}_{CRG}^{*} < 0 )$$

and points down if the CRG slowness is positive

$$( {s}_{CRG}^{*} > 0 ) .$$

The shoulder bed P and S arrival markings indicate that the shoulder bed arrivals are both faster than their corresponding tool layer arrivals and that the shoulder bed is above the well track—an observation which agrees with the density image shown in FIG. 17C. These waveform annotations are very useful in identifying the various dual arrival events present in the waveform measurements.

Correctly identifying the tool layer and shoulder bed compressional and shear slowness is critical to providing accurate formation evaluation answers derived using sonic measurements. This is particularly true when the well track crosses multiple reservoir zones where the porosity estimates for the reservoir layers and drives decisions about the completion design. Here we describe a procedure for (a) separating the CSG apparent slowness estimates for the tool layer and shoulder bed compressional and shear slowness produced by the automated time pick and (b) creating a log display which is useful for this addressing this formation evaluation challenge.

The CSG slowness estimates

$${s}_{CSG}^{*}$$

for the tool layer and shoulder bed compressional and shear slowness are provided by the annotations in FIGS. 19A through 19D. From these CSG slowness estimates, we can create the corresponding four slowness logs (DTCOT, DTCOS, DTSMT, DTSMS) where the first four letters indicate whether this is a compressional (DTCO) or shear slowness (DTSM) log and where the last letter indicates whether this compressional or shear slowness estimate pertains to the tool layer (T) or shoulder bed (S). This can be done by hand or using the automated classifier procedure described below.

The top panel of FIG. 20 shows the tool layer and shoulder bed slowness logs derived from the automated time pick (DTCOT, DTCOS, DTSMT, DTSMS) using the automated classifier workflow listed below alongside the standard commercial compressional (DTCO) and shear (DTSH) logs in the same measured depth interval. The tool layer P and S slowness values are marked in the left panel with gray squares, since the CRG azimuth estimates

$${s}_{CRG}^{*}$$

are not significant for tool layer slowness estimates. The bottom panel of FIG. 20 shows the same logs in a commercial log interpretation software (TechLog). We observe that the commercial compressional log (DTCO) is picking the shoulder bed compressional slowness, while the commercial shear slowness log (DTSH) is picking the tool layer slowness. Thus, the VP/VS ratio and Poisson's ratio derived using the commercial slowness logs through this measured depth interval would be inaccurate and lead to incorrectly derived estimates of tool layer porosity and rock strength. Using the tool layer and shoulder bed slowness derived using the automated time pick would lead to the correct formation evaluation answers for the tool layer. Beyond this, the automated time pick also provides opportunity to estimate the VP/VS and Poisson's ratio for the shoulder bed, thus providing important new formation evaluation estimates of porosity and rock strength in the shoulder bed.

The workflow we use for classifying the automated time pick results into four categories (tool layer compressional, tool layer shear, shoulder bed compressional, and shoulder bed shear) proceeds as follows:
(1) Choose four constants to configure this automated classifier workflow.
   a. Choose a threshold P slowness value, max_{P}, which is larger (i.e. slower) than all the tool layer and shoulder bed P slowness values derived using the automated time pick. This threshold value is intended to separate the tool layer and shoulder bed P slowness from the slower tool layer and shoulder bed S slowness. For the field data example shown here we had max_{P}=90 μs/ft.
   b. Choose a tool layer P slowness event window size, w_{P}, which describes the range of tool layer P CSG slowness values. This window size is intended to help capture the automated time pick slowness values belonging to the tool layer P arrival. All shoulder bed P CSG slowness values will be smaller than the tool layer P CSG slowness values. For the field data example shown here, we used w_{P}=4 μs/ft.
   c. Choose a threshold S slowness value, maxₛ, which is larger (i.e. slower) than all the tool layer and shoulder bed S slowness values derived using the automated time pick. This threshold value is intended to separate the tool layer and shoulder bed S slowness from the slower Stoneley slowness values. For the field data example shown here, we used maxₛ=150 μs/ft.
   d. Choose a tool layer S slowness event window size, wₛ, which describes the range of tool layer P slowness values. This window size is intended to help capture the automated time pick slowness values belonging to the tool layer S arrival. All shoulder bed S CSG slowness values will be smaller than the tool layer S CSG slowness values. For the field data example shown here, we used wₛ=4 μs/ft.
(2) For each measured depth interval where the automated time pick is run, we derive the tool layer and shoulder bed P slowness values as follows:
   a. Sort the CSG slowness values

$${s}_{CSG}^{*}$$

in increasing order.
   b. Find the last CSG slowness value which is smaller than max_{P}. Call this CSG value, s_{max tool p}
   c. Group all the CSG slowness values which are between s_{maxtool p} and s_{maxtool p}−w_{P}. These are the tool layer P slowness values. We index and label them.
   d. Group all the CSG slowness values which are smaller (faster) than s_{max tool p}−w_{P}. These are the shoulder bed P slowness values. We index and label them.
   e. Remove all the tool layer and shoulder bed P values from the sorted list of CSG slowness values.
(3) To then derive the tool layer and shoulder bed S slowness values in the same measured depth interval as step (2) we continue to proceed as follows:
   a. Find the last CSG slowness value which is smaller than maxₛ. Call this CSG value, s_{max tool s}
   b. Group all the CSG slowness values which are between s_{max tool s} and s_{max tool s}−wₛ. These are the tool layer S slowness values. We index and label them.
   c. Group all the CSG slowness values which are smaller (faster) than s_{max tool s}−wₛ. These are the shoulder bed S slowness values. We index and label them.

The output of this automated classification workflow is a labeling of the CSG slowness values

$${s}_{CSG}^{*}$$

produced by the automated time pick as tool layer P, shoulder bed P, tool layer S, and shoulder bed S arrival events. We label them as DTCOT, DTCOS, DTSMT, DTSMS, respectively in the log displays of FIG. 20.

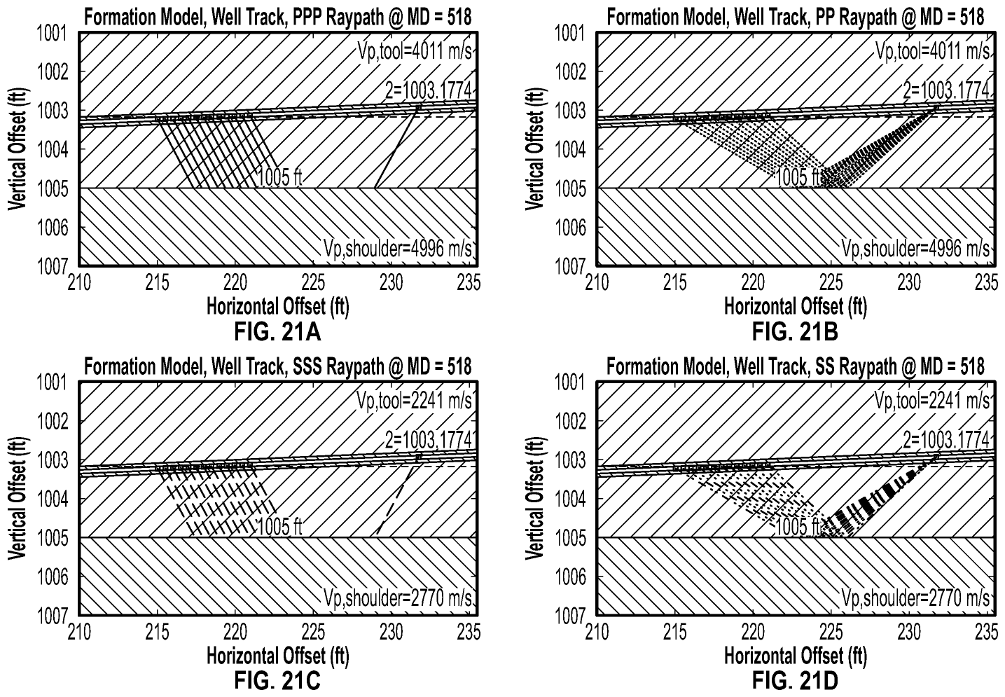

The objective of the ray tracing inversion workflow is to invert the time picks associated with each shoulder bed arrival event for a locally layered model of formation slowness along the well trajectory where dual arrival events are present. Here we discuss an important aspect of this inverse problem—the fact that there are multiple types of commonly observed shoulder bed arrivals. The term ‘raypath type’ is used to describe these various types of shoulder bed arrivals. FIGS. 21A through 21D illustrate some of the most common raypath types.

Raypath type refers to the type of path along which refracted or reflected energy may propagate from source to receiver array through the layered Earth formation. FIGS. 21A through 21D show four commonly observed dual arrival raypath types: PPP refraction, PP reflection, SSS refraction, and SS reflection. FIGS. 21A and 21C show how the PPP and SSS refracted waves first propagate from source to the shoulder bed boundary, then refract along the shoulder bed, and then lastly refract back towards the receiver array. FIGS. 21B and 21D show how the PP and SS reflections originate at the source location, propagate to the shoulder bed boundary, and are then reflected back to the receiver array. Each type of dual arrival event provides different information about the local slowness profile along the well track, so distinguishing the raypath type of a shoulder bed arrival is critical for making a correct interpretation. The individual letters P and S refer to the mode of propagation during each leg of the ray path from source to receiver array. P means the wavefront propagates as a compressional wave along the particular leg of its raypath, and S means that the wavefront propagates as a shear wave along that particular leg of its raypath. All of these raypaths shown in FIGS. 21A through 21D and in the other figures are ray traced according to Snell's Law.

PPP and SSS refractions occur when the Earth formation layer containing the tool sonde (“the tool layer”) is slower than the shoulder bed (vₜₒₒₗ<v_{shoulder}), and the wavefront propagating from source to receiver array refracts and propagates within the shoulder bed along the boundary. The angle of this refraction at the shoulder bed boundary is given by Snell's Law and is the critical refraction angle shown in Equation 9.

$${θ}_{c} = arcsin \frac{{v}_{tool}}{{v}_{shoulder}} \qquad ( 9 )$$

The different types of shoulder bed arrivals illustrated in FIGS. 21A through 21D provide different information about the local formation slowness layering along the well track, so distinguishing the raypath type of the shoulder bed arrival is critical for making a correct interpretation. In particular, the refracted wavefronts propagate within the shoulder bed and so contain information about the shoulder bed velocity whereas the reflected wavefronts do not propagate within the shoulder bed and thus do not provide information about the shoulder bed velocity.

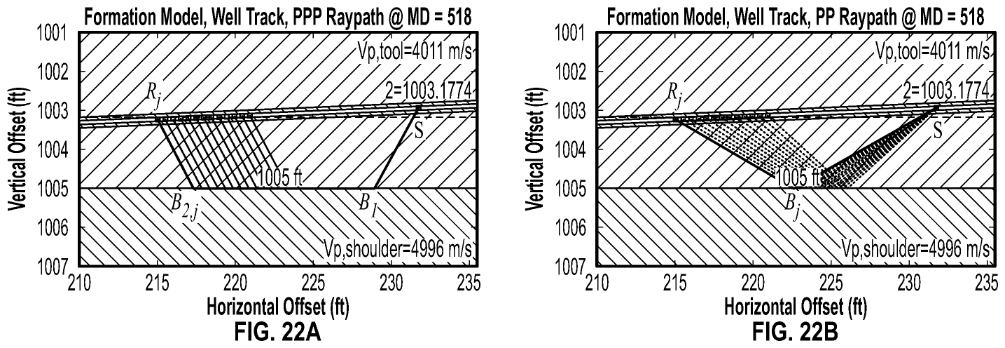

FIGS. 22A and 22B illustrate the travel time calculations between source and receiver array sensors for the refracted and reflected raypath types that are provided as Equation (10) and Equation (11). FIG. 22A labels the PPP raypath between the source S and the j^{th} receiver sensor Rⱼ that includes the two refraction points B₁ and B_{2,j} along the shoulder bed boundary. Equation (10) shows the corresponding travel time calculation which includes three terms, one for each leg of the raypath. FIG. 22B labels the PP raypath between the source S and the j^{th} receiver sensor Rⱼ which includes the reflection points Bⱼ along the shoulder bed boundary. Equation (11) shows the corresponding travel time calculation which includes two terms, one for each of the two legs of the raypath. From Equations (10) and (11), one observes that the travel times for the reflected wavefield do not depend on the shoulder bed velocity v_{shoulder}, so distinguishing whether a shoulder bed arrival is a reflection or refraction is critical for making a correct interpretation.

Note that we have added a superscript ‘i’ in all the terms of Equations (10) and (11) that indexes measurement depth stations along the well track. This corresponds to the index i used in Equations 1-6, as we shall be performing these travel time calculations at each measurement station along the time pick. Note that Equations (10) and (11) have been written in a general manner without specifying explicitly whether the velocities vₜₒₒₗ and v_{shoulder} are P or S velocities. When using Equation (10) to calculate travel times for PPP refractions, vₜₒₒₗ and v_{shoulder} are P velocities, and when using Equation (10) to calculate travel times for SSS refractions, vₜₒₒₗ and v_{shoulder} are S velocities. Equation (11) can use used to calculate travel times for both PP and SS reflections in a similar manner.

$${tt}_{j}^{i} = \frac{‖ {B}_{1}^{i} - {S}^{i} ‖}{{v}_{tool}} + \frac{‖ {B}_{2 , j}^{i} - {B}_{1}^{i} ‖}{{v}_{shoulder}} + \frac{‖ {R}_{j}^{i} - {B}_{2 , j}^{i} ‖}{{v}_{tool}} \qquad ( 10 )$$

$${tt}_{j}^{i} = \frac{‖ {B}_{j}^{i} - S ‖}{{v}_{tool}} + \frac{‖ {R}_{j}^{i} - {B}_{j}^{i} ‖}{{v}_{tool}} \qquad ( 11 )$$

A ray tracing inversion of the time picks produced by the automated time pick consists of two parts—a model selection problem and a parametric inversion problem. The model selection problem consists of identifying the raypath type of the shoulder bed arrival. This model selection problem determines the appropriate model parameterization for the shoulder bed arrival event. The parametric inversion consists of inverting the shoulder bed arrival travel times

$${tt}_{j , k}^{i}$$

from Equation 6 for the corresponding model parameters.

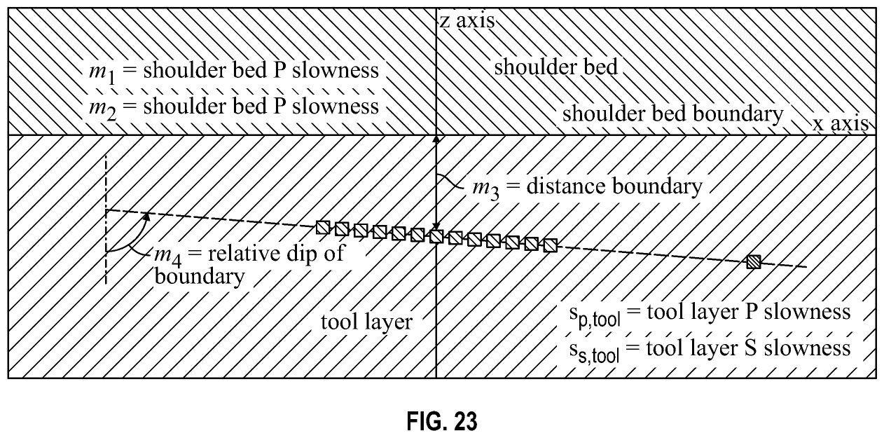

The model parameters of interest for the ray tracing inversion include: (a) the shoulder bed P slowness, m₁; (b) the shoulder bed S slowness, m₂; (c) distance to the shoulder bed, m₃; (d) relative dip of the shoulder bed, m₄. The layered Earth model parameterization used by the ray tracing inversion has horizontal layers and an arbitrarily deviated well track as illustrated in FIG. 23. The distance to the shoulder bed m₃ is constrained to be positive, m₃>0. The relative dip of the shoulder bed m₄ is measured from the vertical, so that m₄=900 means that the acoustic logging tool and the formation layers are all parallel to one another. In addition, the tool layer P slowness s_{p,tool} and tool layer S slowness s_{s,tool}, derived using the automated classification workflow described above or via other slowness logs, will be treated as an input parameter and will not be inverted for by the ray tracing inversion.

From this layered Earth model parameterization, we can calculate the travel times between source and the various receiver sensors following Equation 10 and Equation 11 for the four different raypath types. In this way, we can formulate a function ƒ(m) which relates the model parameters m=(m₁,m₂,m₃,m₄) to the corresponding forward modeled travel times

$${tt}_{j}^{i}$$

as illustrated in Equation 12.

$${tt}_{j}^{i} = f ( m ; {s}_{p , tool} , {s}_{s , tool} , raypath\_type ) \qquad ( 12 )$$

The parameters s_{p,tool},s_{s,tool}, raypath_type listed after the model parameters m are hyperparameters and will be treated as input parameters and not be inverted for here.

We can further enumerate the details of Equation 12 in Equations 13a-d that show explicitly on which of the model parameters the travel times

$${tt}_{j}^{i}$$

depend for the different raypath types.

$${tt}_{j}^{i} = f ( {m}_{1} , {m}_{3} , {m}_{4} ; {s}_{p , tool} , {s}_{s , tool} , PPP ) \qquad ( 13 a )$$

$${tt}_{j}^{i} = f ( {m}_{2} , {m}_{3} , {m}_{4} ; {s}_{p , tool} , {s}_{s , tool} , SS ) \qquad ( 13 b )$$

$${tt}_{j}^{i} = f ( {m}_{3} , {m}_{4} ; {s}_{p , tool} , {s}_{s , tool} , PP ) \qquad ( 13 c )$$

$${tt}_{j}^{i} = f ( {m}_{3} , {m}_{4} ; {s}_{p , tool} , {s}_{s , tool} , SS ) \qquad ( 13 d )$$

We note that the forward model ƒ(m) only models the travel times

$${tt}_{j}^{i}$$

as a function of source-receiver offset j and measured depth position index i, not as a function of nominal receiver azimuth k. The ray tracing inversion is only intended to map the shoulder bed position in 2D relative to the well track. Indeed, the distance to boundary parameter is always positive m₃>0, so the shoulder bed boundary used by the ray tracing inversion in FIG. 23 will always be above the well track. We shall map the shoulder bed boundary in 3D along the well trajectory and construct the corresponding curtain section display of the finalized inversion result in the next section.

Here is it helpful to give the local coordinates of the receiver sensor (rxⱼ, rzⱼ) and source (sx, sz) locations used by the ray tracing inversion. The ray tracing inversion places the shoulder bed boundary along the x-axis and the center of the receiver array m₃ ft below the origin.

$${rx}_{j} = ( {z}_{j} - {z}_{M} ) cos {m}_{4} \qquad ( 14 a )$$

$${rz}_{j} = {m}_{3} + ( {z}_{j} - {z}_{M} ) sin {m}_{4} \qquad ( 14 b )$$

$$sx = ( TR + ( {z}_{1} - {z}_{M} ) ) cos {m}_{4} \qquad ( 14 c )$$

$$sz = {m}_{3} + ( TR + ( {z}_{1} - {z}_{M} ) ) sin {m}_{4} \qquad ( 14 d )$$

Here z_{M} is the mean source-receiver offset and TR is the source-receiver spacing. Again, the parameterization does not model the azimuthal receiver sensors, only the source-receiver offsets. The ray tracing inversion is only intended to map the shoulder bed in 2D relative to the well track.

Here we demonstrate the ray tracing inversion to determine the raypath type of shoulder bed arrival events (i.e., solve the model selection problem) and also solve corresponding parametric inversion to determine a local layered model of slowness. We show this first for forward modeled shoulder bed arrival events where we know the raypath type and the correct inverted parameter values.

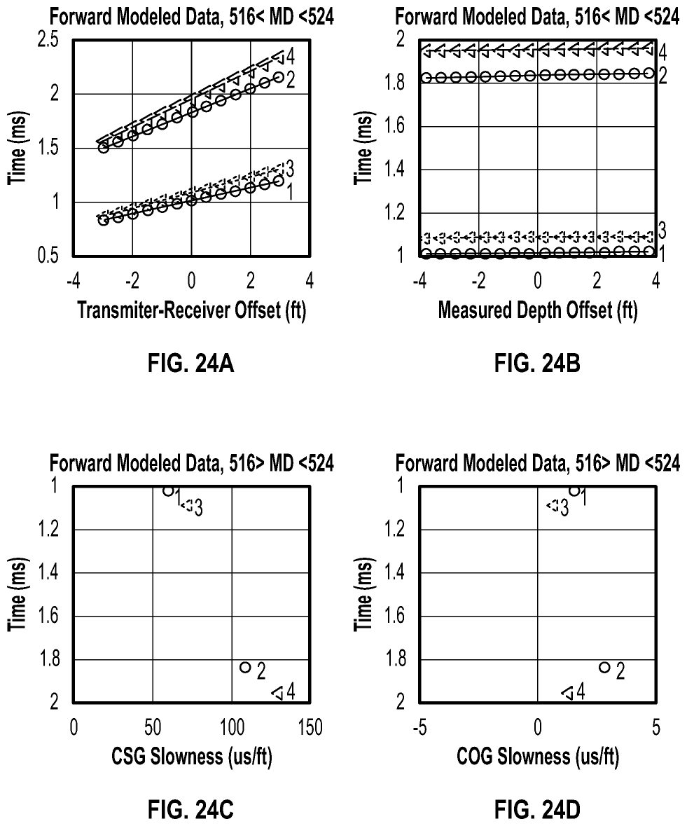

We begin by preparing the input data shown in FIGS. 24A through 24D for the ray tracing inversion by forward modeling the travel times

$${tt}_{j}^{i}$$

and the corresponding peak CSG and COG slowness values

$${s}_{COG}^{*} , {s}_{CSG}^{*}$$

at 15 measurement depth stations along the well track shown in FIGS. 21A through 21D for each of the PPP, SSS, PP, and SS raypath types using Equations 13a-d. These travel times

$${tt}_{j}^{i}$$

are calculated for all 13 source-receiver offsets zⱼ at each of the 15 measurement depth stations mdᵢ. Here z₁=10, z₂=10.5, . . . , z₁₃=16 ft, and md₁=516.5, md₂=517, . . . , md₁₅=523.5 ft.

FIGS. 24A and 24B show these travel times

$${tt}_{j}^{i} .$$

The annotations 1, 2, 3, and 4 used in FIGS. 24A through 24D correspond to the raypath types PPP, SSS, PP, and SS, respectively. FIG. 24A shows the forward modeled travel times

$${tt}_{j}^{i}$$

for the 13 transmitter-receiver offsets at the 8th (i=8) measurement depth station md₈=520, while FIG. 24B shows the forward modeled travel times

$$t {t}_{j}^{i}$$

for the 7th transmitter-receiver offset z₇=13.5 ft for all 15 measurement depth stations.

The

$${s}_{C O G}^{*} and {s}_{C S G}^{*}$$

slowness values that correspond to the forward modeled travel times

$$t {t}_{j}^{i}$$

are shown in FIGS. 24C and 24D for the four raypath types. The

$${s}_{COG}^{*} and {s}_{CSG}^{*}$$

slowness values are estimated by performing a least-squares fit of the travel times according to Equation 15.

$${tt}_{j}^{i} = τ * + {s}_{CSG}^{*} ( {z}_{j} - {z}_{7} ) + {s}_{COG}^{*} ( {md}_{i} - {md}_{8} ) \qquad ( 15 )$$

Looking further at the details of FIGS. 24C and 24D, we observe how the

$${s}_{C O G}^{*} and {s}_{C S G}^{*}$$

peaks are separated from one another and also characterize the slopes and arrival times of the forward modeled travel times

$$t {t}_{j}^{i}$$

shown in FIGS. 24A and 24B. This separation is what permits the ray tracing inversion to distinguish the correct raypath type for each of these four arrival events.

Table 1 (illustrated in the Appendix) provides a summary of the ray tracing inversion results for the input data described in FIGS. 24A through 24D. The table row indexes #1-#4 correspond to the indices #1-4 used to label the forward modeled data shown in FIGS. 24A through 24D. The entries in the table columns labeled Tau_ms, pCOG_usFt, and pCSG_usFt correspond to the peak

$${τ}^{*} , {s}_{C O G}^{*} , {s}_{C S G}^{*}$$

values estimated from the forward modeled travel times using Equations 15. The last four columns contain the data misfit when inverting the forward modeled travel times

$$t {t}_{j}^{i}$$

using the four Equations 13a-d using a Levenberg-Marquardt inversion algorithm. The misfit errors are color-coded according to their magnitude. The diagonal checkmarks indicate that the ray tracing inversion with the smallest misfit corresponds with the raypath type of the arrival event. In this way, we demonstrate that the ray tracing inversion has the capability to distinguish the correct raypath type of a dual arrival event.

Table 2 (illustrated in the Appendix) provides a more detailed summary of the ray tracing inversion results for each of the four arrival events described in FIGS. 21A through 21D and listed in the rows of Table 1. Each panel shows the event index in the second column of the first row. Each table's second column also repeats the corresponding

$${τ}^{*} , {s}_{C O G}^{*} , {s}_{C S G}^{*}$$

values listed in the corresponding row of Table 1. The last four columns of the first row give the data misfit when inverting the travel times using Equations 13a-d and a Levenberg-Marquardt inversion algorithm. To help improve readability and highlight the correspondence with the entries in Table 1, the last four columns are color-coded according to the magnitude of the inversion misfit, and we mark the event raypath type with the smallest data misfit with a circled checkmark indicating the ray tracing inversion raypath type selection. The last four rows of this selected column provide the corresponding inverted parameter values which agree correctly with the input formation model. Note that the NaN values shown for some of the inverted model parameter values mean that that model parameter was not inverted.

Here we demonstrate the ray tracing inversion to determine the raypath type of shoulder bed arrival events (i.e. the model selection problem) and solve corresponding parametric inversion to determine a local layered model of slowness for field acoustic measurements. We perform these tasks for four of the automated time picks produced using the field data example displayed in FIGS. 17A through 17C. These time picks (#1, #4, #7, and #11) from the measured depth interval between 9165 ft and 9205 ft MD are highlighted in FIG. 25.

We begin by preparing the input data for the ray tracing inversion. The time picks

$$t {t}_{j , k}^{i}$$

produced by the automated time pick using Equation 6 characterize the event's moveout as a function of source-receiver offset (j), measured depth (i), and nominal receiver azimuth (k). However, the input to our ray tracing inversion workflow only requires input travel times

$$t {t}_{j}^{i} ,$$

because the ray tracing inversion is only determining a 2D mapping of the shoulder bed relative to the well track. In the next section, we shall use the peak common ring gather slowness value

$${s}_{C R G}^{*}$$

to determine whether the shoulder bed is above or below the well track and place the shoulder bed in 3D along the well trajectory.

To prepare the input data for the ray tracing inversion, we average arrival times as a function of nominal receiver azimuth as in Equation 16 where the number of nominal receiver azimuths here is M=8. The resulting time picks

$$t {t}_{j}^{i}$$

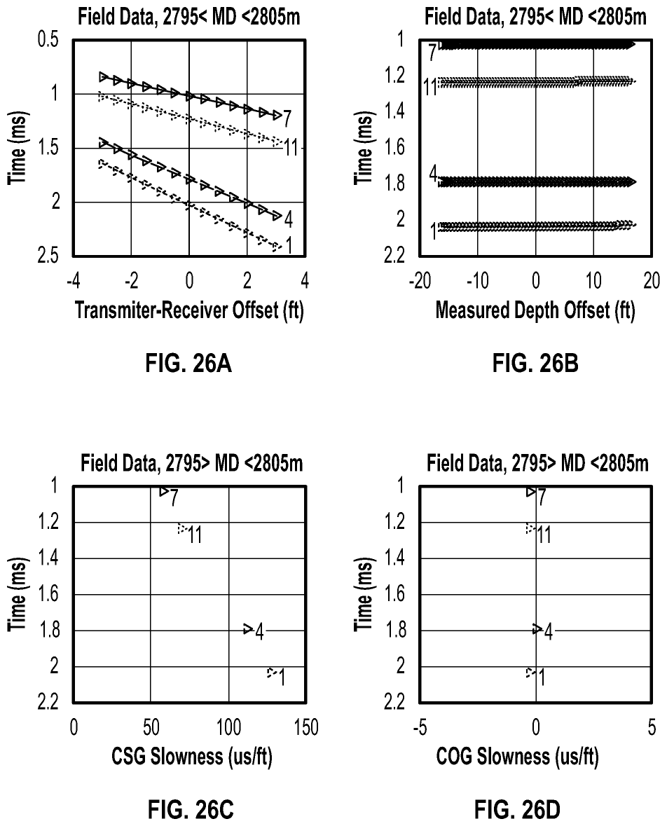

for arrival events #1, #4, #7, and #11 are shown in FIGS. 26A through 26D and will be used in the ray tracing inversion.

$$t {t}_{j}^{i} = \frac{1}{M} {\sum }_{k = 1}^{M} t {t}_{j , k}^{i} \qquad ( 16 )$$

FIG. 26A shows the time pick values

$$t {t}_{j}^{i}$$

from Equation 16 for the 13 transmitter-receiver offsets j at the central measurement depth station i=33 along the time pick, while FIG. 26B shows the time pick values

$${tt}_{j}^{i}$$

from Equation 16 for the 7th source-receiver offset (j=7) for all 66 measurement depth stations along the time pick. FIGS. 26C and 26D show the peak

$${τ}^{*} , {s}_{COG}^{*} , and {s}_{C S G}^{*}$$

values produced directly by the automated time pick for the time picks highlighted in FIG. 25.

Table 3 (illustrated in the Appendix) provides a summary of the ray tracing inversion results for input data described in FIGS. 26A through 26D. The entries in the table columns marked Tau_ms, pCOG_usFt, pCRG_usFt, and pCSG_usFt correspond to the peak

$${τ}^{*} , {s}_{C O G}^{*} , {s}_{C R G}^{*} and {s}_{C S G}^{*}$$

produced by the automated time pick. The last four columns contain the data misfit when inverting the travel times

$$t {t}_{j}^{i}$$

using the four Equations 13a-d with a Levenberg-Marquardt inversion algorithm. The misfit errors are color-coded according to their magnitude. The diagonal checkmarks indicate that the ray tracing inversion with the smallest misfit corresponds with the raypath type of the arrival event.

From visual inspection of the #1, #4, #7, and #11 arrival events in FIG. 25, we know that #1 and #11 are the tool layer S and tool layer P arrival, respectively, because of their lateral continuity as a function of measured depth. Further, #4 and #7 are the shoulder bed S and shoulder bed P arrival events, respectively, because they arrive before the corresponding tool layer arrivals and because of their faster CSG slowness values as seen in FIG. 26C. In this way, we demonstrate that the ray tracing inversion distinguishes the correct raypath type of a dual arrival event for this field data example.

Table 4 (illustrated in the Appendix) provides a more detailed summary of the ray tracing inversion results for the shoulder bed arrival events #4 and #7 listed in the rows of Table 3. FIGS. 26A through 26D the event index in the second column of the first row. Each table's second column also repeats the corresponding

$${τ}^{*} , {s}_{C O G}^{*} , {s}_{CSG}^{*}$$

values listed in the corresponding row of Table 3. The last four columns of the first row give the data misfit when inverting the travel times using Equations 13a-d and a Levenberg-Marquardt inversion algorithm. To help improve readability and highlight the correspondence with the entries in Table 3, the last four columns are color-coded according to the magnitude of the inversion misfit, and we mark the event raypath type with the smallest data misfit with a circled checkmark indicating the ray tracing inversion raypath type selection.

While the log display of shoulder bed and tool layer slowness shown in FIG. 20 is very useful for formation evaluation purposes, a curtain plot section showing the formation layering above and below the well track with estimated tool layer and shoulder bed slowness is also helpful for well placement. Here we first construct this curtain section from the ray tracing inversion results for the forward modeled time picks discussed earlier. The main steps are (1) calculate the local coordinates of the raypaths used by the ray tracing inversion; (2) calculate the reflection/rotation transformation which maps the local coordinates of the source and receiver positions to the coordinates of the source and receiver positions along the well track (this step uses the azimuth information

$${s}_{CRG}^{*}$$

from the automated time pick.); (3) apply this reflection/rotation transformation to the local raypaths determined by the ray tracing inversion to obtain a mapping of the shoulder bed along the well track; and (4) combine the mappings from step (3) for all measurement depth positions along the well track to construct the curtain plot display.

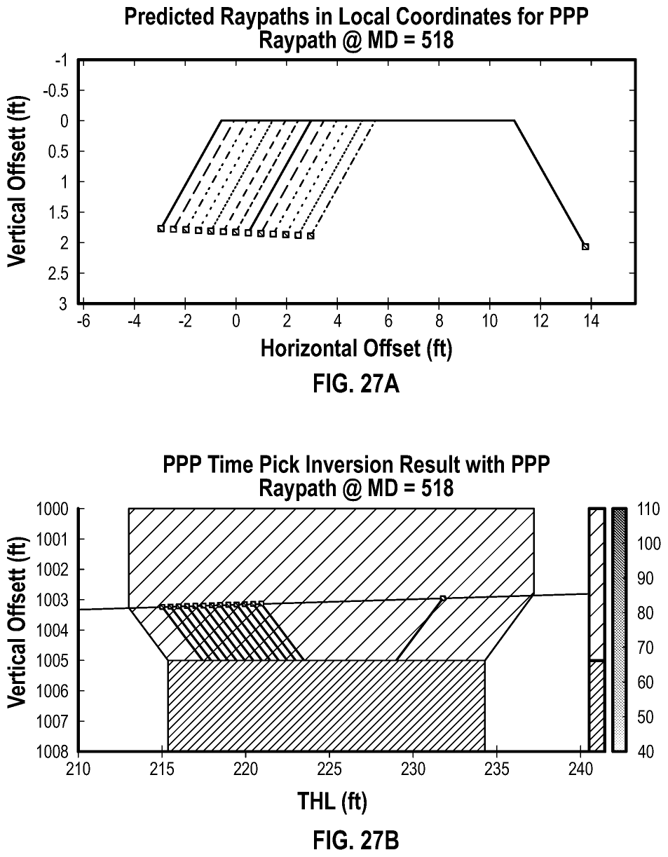

The detailed ray tracing inversion results shown in Table 2 provide distance to (m₃) and the relative dip of (m₄) the shoulder bed boundary. We can use the parameterization from Equation 14 to calculate the local coordinates of the receiver sensor (rxⱼ, rzⱼ) and source (sx, sz). FIG. 27A shows the source (sx, sz) as the square around 14 ft and the receiver positions (rxⱼ, rzⱼ) as the squares from around −3 ft to +3 ft as well as the shoulder bed boundary location shown as the horizontal line at vertical offset 0 ft. FIG. 27B shows the receiver positions (RXⱼ, RZⱼ) and source (SX,SZ) positions along the well trajectory for the measured depth station at measured depth 518 ft.

There is a reflection/rotation transformation L followed by a translation T which maps the local coordinates used by the ray tracing inversion for the source (sx, sz) and receiver positions (rxⱼ, rzⱼ) to the receiver positions (RXⱼ, RZⱼ) and source (SX,SZ) positions along the well trajectory. The local coordinate system used by the ray tracing inversion places the shoulder bed boundary above the well track. If the automated time pick described earlier has

$${s}_{C R G}^{*} > 0$$

indicating that the shoulder bed is below the well track, we begin by replacing local x-coordinates of the source and receivers with their negative values, thus placing the shoulder bed on the opposite side of the well track. We then calculate the rotation angle Γ−γ between the local coordinates of the source-receiver axis and the source-receiver axis along the well trajectory as in Equation 17 to produce the rotation matrix L.

$$γ = a tan 2 ( - sign ( {s}_{CRG}^{*} ) * ( s x - r {x}_{1} ) , sz - r {z}_{1} ) \qquad ( 17 )$$

$$Γ = a tan 2 ( SX - {RX}_{1} , SZ - R {Z}_{1} )$$

$$L ( \begin{matrix}x \\ z\end{matrix} ) = ( \begin{matrix}cos ( Γ - γ ) & sin ( Γ - γ ) \\ sin ( Γ - γ ) & - cos ( Γ - γ )\end{matrix} ) ( \begin{matrix}- sign ( {s}_{CRG}^{*} ) * x \\ z\end{matrix} )$$

The translation matrix T is then specified by the first line of Equation 18, while the second line of Equation 18 describes the complete mapping between the local coordinates used by the ray tracing inversion and the coordinates along the well track.

$$T ( \begin{matrix}x \\ z\end{matrix} ) = ( \begin{matrix}x - {t}_{x} \\ z - {t}_{z}\end{matrix} ) \qquad ( 18 )$$

$$( \begin{matrix}{t}_{x} \\ {t}_{z}\end{matrix} ) = ( \begin{matrix}SX \\ SZ\end{matrix} ) - L ( \begin{matrix}sx \\ sz\end{matrix} )$$

Here, we highlight that when the acoustic receiver array does not have azimuthal sensors so that the automated time pick operates in the 3D domain

$${τ}^{*} , {s}_{C O G}^{*} , {s}_{CSG}^{*}$$

and does not tell whether the shoulder bed is above or below the well track, we can use azimuthal information from other borehole measurements such as the density image shown in FIG. 17C to provide what would be the appropriate value for

$$- sign ( {s}_{CRG}^{*} ) .$$

FIG. 28 illustrates the procedure used to construct the curtain section display of the ray tracing inversion result for a single PPP time pick. The main idea is to highlight the zones along the well track where the refracted wavefield travels at the velocities (slownesses) predicted by the ray tracing inversion. The four corners of the quadrilateral marked as Zone 2 are computed using the first and last raypaths produced for the first and last measured depth positions for the time pick. The boundaries of Zones 1 and 3 are determined using the top and bottom edges of the Zone 2 quadrilateral and extended vertically to the top and bottom of the curtain section display. Zones 1 and 2 are determined from tool layer slowness estimate sₜₒₒₗ, and Zone 3 is determined from shoulder bed slowness estimate which is either m₁ or m₂. The true formation slowness for this synthetic example is shown as the column along the right edge of FIG. 28.

FIGS. 29A and 29B show the final curtain plot section inversion result for all the PPP time picks computed along the well track for the synthetic example shown in FIG. 21A. The curtain section shown in FIG. 29A is produced by computing a spatial average of the individual curtain plot sections such as is shown in FIG. 28. The curtain section shown in FIG. 29B is produced from FIG. 29A after modulating, for example, the color saturation to convey an indication of depth of investigation which is roughly 1 spatial wavelength of the refracted sonic wave (about 2 feet) beyond the mapped interfaces.

FIGS. 30A and 30B show final curtain plot sections produced by the ray tracing inversion for the field measurements shown in FIG. 25. FIG. 30A shows the curtain plot section produced using the PPP refraction events numbered from left to right as #11, 5, 11, 7, 6, 3, in FIG. 25, while FIG. 30B shows the curtain plot section produced using the SSS refractions highlighted from left to right as events #6, 3, 5, 4, 9, 6, and 13. The line segments in both FIGS. 30A and 30B (e.g., from between around 6228 ft and 6232 ft true vertical depth in FIG. 30A and from between around 6230 ft and 6233 ft true vertical depth in FIG. 30B) indicate the estimated positions of the shoulder bed along the well track as determined by the ray tracing inversions used to construct the curtain sections.

The estimates for tool layer compressional (DTCOT) and shear slowness (DTSMT) used by the ray tracing inversion are shown in FIG. 20 and were provided by the automated time pick and classification workflows. The arrival events selected to produce the curtain plot section were selected and classified as PPP and SSS events by the ray tracing inversion as shown in Table 3 where event #7 from the middle measured depth interval highlighted from FIG. 25 is classified as PPP, while event #4 is classified as SSS. We observe that because the CRG slowness value

$${s}_{C R G}^{*} < 0$$

is negative for all the selected events, the shoulder bed shown in the curtain plot sections of FIGS. 30A and 30B is consistently shown above the well track. Close inspection of the two curtain plot sections indicates that the shoulder bed is closer to the well track in the SSS inversion result than in the PPP inversion result, so a ray tracing inversion which simultaneously considers the constraints of the PPP and SSS arrival events may help reconcile these differences.

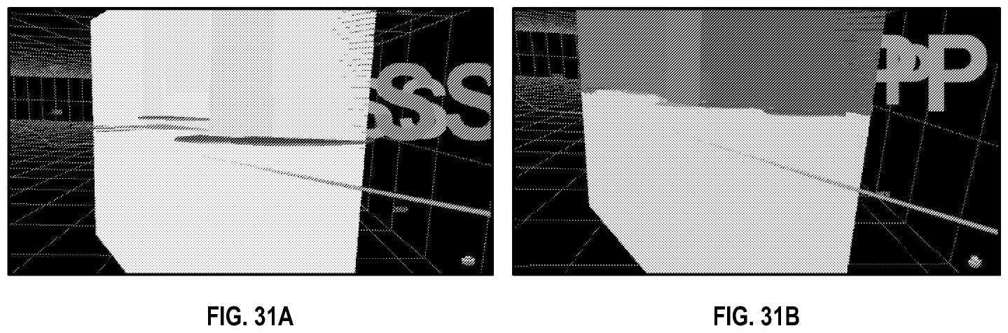

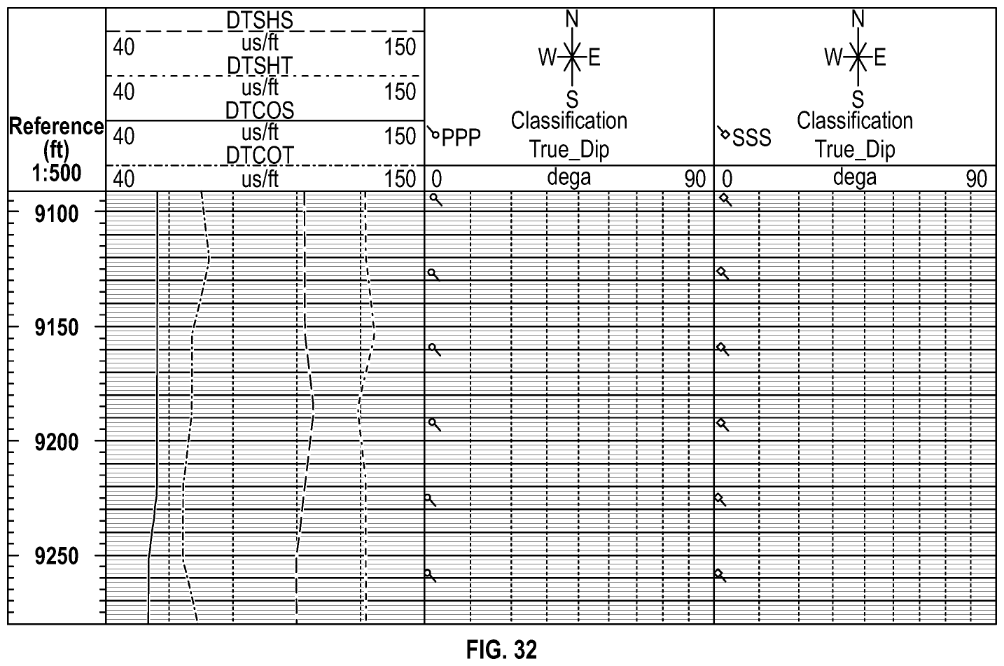

While the slowness logs depicted in FIG. 20 and the curtain sections shown in FIGS. 29A and 29B and in FIGS. 30A and 30B are useful for formation evaluation and well placement, here we highlight these workflow outcomes in 3D as shown in FIGS. 31A and 31B and FIG. 32 to demonstrate their additional interpretation value.

FIG. 31A shows the same curtain sections as in FIGS. 30A and 30B, respectively, but now they appear along the well trajectory in 3D. To accomplish this mapping, we compute the source and receiver positions along the well track in 3D and then apply locally linear transformations very analogous to the 2D mappings shown in Equations 17 and 18. The bed boundary positions marked with line segments in FIGS. 30A and 30B are mapped to the 3D disks shown in FIGS. 31A and 31B. Moreover, we can compute the true dip and azimuth of those 3D disks and form the corresponding logs shown in Tracks 3 and 4 of FIG. 32. These true dip and azimuth logs are useful in understanding the formation structure and can be compared to the true dip and azimuth logs derived from formation image logs like fullbore formation micro imager logs, or or ultrasonic formation imager logs, or the like.

The embodiments presented herein provide a method of automated acoustic tool waveform time pick, as well as a computer readable tangible medium having stored thereon computer instructions to cause a processor to perform methods of automated acoustic tool waveform time pick as described and shown herein.

For example, in certain embodiments, a method of an automated time pick for dual arrival waveform arrival events recorded by an acoustic logging tool at least one measured depth location with at least one source and one receiver sensor may include computing tau-P transform in common shot gather CSG domain for every measured depth MD location and for each nominal receiver azimuth; concatenating the results into a 4D cube; permuting cube indices to be tau-CSG×nominal receiver azimuth×MD×p-CSG; computing tau-P transform in common ring gather CRG domain for each MD×p-CSG slice; permuting cube indices to be tau-CRG×MD×p-CRG×p-CSG, and wherein the cube is stored for the event localization; computing tau-P transform in common offset gather COG domain for each p-CRG×p-CSG slice providing 4D cube tau-COG×p-COG×p-CRG×p-CSG; convolving the 4D cube as a function of tau-COG with a 1D boxcar function of duration Δ=0.2 milliseconds; using a local median filter on the 4D tau-P cube to reduce noise and sharpen peaks; finding and sorting the local maxima in the 4D cube; selecting a local max and using an event localization for projected waveforms from the tau-CRG×MD×p-CRG×p-CSG cube to find start and end measured depth of the arrival event in the common offset gather domain; using local maxima and start and end measured depth of event to produce a set of arrival times for dual arrival event in common offset, common shot, and common ring gather domains; and creating a waveform display overlay using said arrival times to mark the arrival events in the waveform measurements.

In addition, in certain embodiments, a method of producing a log of tool layer and shoulder bed slowness using common shot gather slowness estimates produced by an automated time pick of dual arrival events may include choosing a threshold P slowness value which is larger (i.e. slower) than the tool layer and shoulder bed P slowness; choosing a tool layer P slowness event window size, which describes the range of tool layer p-CSG slowness values derived from the automated time pick; determining all the p-CSG slowness values that are smaller than the max P slowness value; grouping all these p-CSG slowness values within the P slowness event window size of the maximum P slowness value and average these to form the tool layer P slowness; grouping the remaining p-CSG slowness values and average these to form the shoulder bed apparent P slowness; removing the p-CSG slowness values that are smaller than the max P slowness value; choosing a threshold shear S slowness value which is larger (i.e. slower) than the tool layer and shoulder bed S slowness and smaller than the Stoneley slowness; choosing a tool layer shear S slowness event window size, which describes the range of tool layer p-CSG slowness values derived from the automated time pick; determining all the p-CSG slowness values that are smaller than the max shear S slowness value; grouping all the p-CSG slowness values within the shear S slowness event window size of the maximum S slowness value and average these to form the tool layer S slowness; and grouping the remaining p-CSG slowness values and average these to form the shoulder bed apparent shear S slowness.

In addition, in certain embodiments, a method of inverting the travel times produced by an automated time pick of dual arrival event to determine the event raypath type and local model parameters describing the shoulder bed may include parameterizing a layered model with of at least a tool layer and shoulder bed and an acoustic tool with at least one source and receiver array (e.g., the local model parameters including at least one of tool layer slowness, shoulder bed slowness, distance to shoulder bed, and dip of shoulder bed); preparing a forward modeling that maps said layered model to predicted dual arrival travel times for different raypath types (e.g., raypath types including at least one of p-reflection, p-refraction, s-reflection, and s-refraction); using an inversion workflow to determine the model parameters that best fit the travel times produced by the automated time pick for each of the different raypath types; selecting the raypath type with the best fit to the travel times as the raypath type of the dual arrival event; and selecting the local model parameters corresponding to the selected raypath type as the local model parameters of the shoulder bed.

In addition, in certain embodiments, a method to use the local parameters of shoulder bed produced by a ray tracing inversion of dual arrival event travel times to form a curtain plot section of the formation slowness along the well trajectory may include making a linear mapping from source and receiver position used by the ray tracing inversion layered model parameterization to the actual source and receiver position along the well track in 2D or 3D; applying the linear mapping to the ray tracing inversion's estimated shoulder bed boundary position to obtain the position of the shoulder bed boundary in 2D or 3D along the well track. Said linear mapping to include azimuth direction to shoulder bed produced by common ring gather slowness value produced by automated time pick of dual arrival event or azimuth information derived from borehole image log; using the position of the shoulder bed boundary in 2D or 3D along the well track, tool layer slowness, and shoulder bed slowness to form a layered slowness model along the well trajectory in 2D or 3D; and estimating the orientation of the 3D shoulder bed boundary to form a log of the true dip and azimuth of the shoulder bed.

The embodiments described herein may be implemented by an acoustic logging data processing system that includes, among other features, memory media storing processor-executable instructions thereon, and one or more processors configured to execute the processor-executable instructions stored in the memory media such that the processor-executable instructions, when executed by the one or more processors cause the acoustic logging data processing system to perform the data processing and analysis techniques described herein. In general the embodiments described herein enable the provision of, among other things, log displays of tool layer and shoulder bed compressional and shear slowness. However, in addition, in certain embodiments, the data processing and analysis techniques described herein may be used by the acoustic logging data processing system to send control commands to an acoustic logging tool that is used to detect data relating to dual arrival waveform events, as described in greater detail herein.

In certain embodiments, the one or more processors of the acoustic logging data processing system may include a microprocessor, a microcontroller, a processor module or subsystem, a programmable integrated circuit, a programmable gate array, a digital signal processor (DSP), or another control or computing device. In certain embodiments, the one or more processors of the acoustic logging data processing system may include machine learning and/or artificial intelligence (AI) based processors. In certain embodiments, the memory media of the acoustic logging data processing system may be implemented as one or more non-transitory computer-readable or machine-readable storage media. In certain embodiments, the memory media of the acoustic logging data processing system may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the processor-executable instructions and associated data may be provided on one computer-readable or machine-readable storage medium of the memory media of the acoustic logging data processing system, or alternatively, may be provided on multiple computer-readable or machine-readable storage media distributed in a large system having possibly plural nodes. Such computer-readable or machine-readable storage medium or media are considered to be part of an article (or article of manufacture), which may refer to any manufactured single component or multiple components. In certain embodiments, the memory media of the acoustic logging data processing system may be located either in the machine running the machine-readable instructions, or may be located at a remote site from which machine-readable instructions may be downloaded over a network for execution.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and/or within less than 0.01% of the stated amount. As another example, in certain embodiments, the terms “generally parallel” and “substantially parallel” or “generally perpendicular” and “substantially perpendicular” refer to a value, amount, or characteristic that departs from exactly parallel or perpendicular, respectively, by less than or equal to 15 degrees, 10 degrees, 5 degrees, 3 degrees, 1 degree, or 0.1 degree.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims. It is also contemplated that various combinations or sub-combinations of the specific features and aspects of the embodiments described may be made and still fall within the scope of the disclosure. It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above.

TABLE 1
Summary of model selection procedure results for the four arrival events described in the panels of FIG. 16.
The row indices #1-#4 in the first column correspond to the indices #1-4 used to label the forward modeled data
shown in FIG. 19. The last four columns contain the data misfit when inverting these forward modeled travel times
using the four Equations 13a-d and are color-coded according to the misfit magnitude. The circled checkmarks indicate
that the ray tracing inversion has the capability to distinguish the correct raypath type of a dual arrival event.
APPENDIX

| | | | pCOG_{—} | pCRG_{—} | pCSG_{—} | Tau_ms_{—} | refraction_{—} | refraction_{—} | reflection_{—} | reflection_{—} |
|---|---|---|---|---|---|---|---|---|---|---|
| E | wave_type | Tau_ms | usFt | usFt | usFt | matchTT | ppp | sss | pp | ss |
| 1 | refraction_ppp | 1.0194 | 1.5814 | NaN | 60.2094 | 1.0194 | ✓ 0.0000 | 8.2072 | 0.1472 | 155.9638 |
| 2 | refraction_sss | 1.8315 | 2.7904 | NaN | 108.6252 | 1.8315 | 108.0848 | ✓ 0.0000 | 2.7246 | 0.9127 |
| 3 | reflection_pp | 1.0899 | 0.7419 | NaN | 72.5820 | 1.0899 | 0.0002 | 3.3480 | ✓ 0.0000 | 130.7091 |
| 4 | reflection_ss | 1.9507 | 1.3279 | NaN | 129.9091 | 1.950 | 147.9774 | 0.0007 | 5.0042 | ✓ 0.0000 |

TABLE 2
Details of ray tracing inversion results for each of the four arrival events listed in the rows
of Table 1. Each panel shows the event index in the second column of the first row. The second
$column also repeats the {τ}^{*} , {s}_{COG}^{*} , {s}_{CSG}^{*} values listed in the corresponding row of Table 1. The last$
four columns of the first row of each table give the data misfit when inverting the travel times
using Equations 13a-d, and those columns are color-coded according to the magnitude of the
inversion misfit. The last four rows of each table provide the inverted parameter values.
APPENDIX

| Results | event_01 | refraction_ppp | refraction_sss | reflection_pp | reflection_ss |
|---|---|---|---|---|---|
| resnorm | NaN | ✓ 1.4098e−24 | 8.2072 | 0.1472 | 155.9638 |
| pCSG_usFt | 60.2094 | 60.2094 | 88.1598 | 68.4726 | 136.0119 |
| pCOG_usFt | 1.5814 | 1.5814 | −2.1556 | 7.1691 | −0.0379 |
| Tau_ms_matchTT | 1.0194 | 1.0194 | 1.2110 | 1.0370 | 1.8739 |
| timeLag_us | NaN | −0.0035 | −0.0240 | −10.0000 | −0.1347 |
| distance ToBoundary ... | NaN | 1.8532 | 0.1242 | 0 | 0.1292 |
| dip_degree | NaN | 89.0000 | 90.5911 | 78.9955 | 90.6411 |
| shoulder Vp_m/s | NaN | 4.9960e+03 | NaN | NaN | NaN |
| shoulderVs_m/s | NaN | NaN | 3500 | NaN | NaN |
| Results | event_02 | refraction_ppp | refraction_sss | reflection_pp | reflection_ss |
| resnorm | NaN | 108.0848 | ✓ 2.7027e−24 | 2.7246 | 0.9127 |
| pCSG_usFt | 108.6252 | 72.3693 | 108.6252 | 49.8437 | 136.0119 |
| pCOG_usFt | 2.7904 | 0.0014 | 2.7904 | −13.2169 | −0.0249 |
| Tau_ms_matchTT | 1.8315 | 1.1138 | 1.8315 | 1.8269 | 1.8740 |
| timeLag_us | NaN | 3.1359e−04 | −0.0968 | 10.0000 | −0.1172 |
| distance ToBoundary ... | NaN | 2.5145 | 1.8537 | 10.5025 | 0.1048 |
| dip_degree | NaN | 89.9983 | 89.0000 | 96.0955 | 90.5203 |
| shoulder Vp_m/s | NaN | 4.2116e+03 | NaN | NaN | NaN |
| shoulder Vs_m/s | NaN | NaN | 2.7700e+03 | NaN | NaN |
| Results | event_03 | refraction_ppp | refraction_sss | reflection_pp | reflection_ss |
| resnorm | NaN | 2.0861e−04 | 3.3480 | ✓ 0.0000 | 130.7091 |
| pCSG_usFt | 72.5820 | 72.0796 | 88.3982 | 72.5820 | 136.0119 |
| pCOG_usFt | 0.7419 | 0.5754 | −2.6370 | 0.7419 | −0.0376 |
| Tau_ms_matchTT | 1.0899 | 1.0899 | 1.2131 | 1.0899 | 1.8739 |
| timeLag_us | NaN | −0.0125 | −0.0292 | −0.0000 | −0.1367 |
| distanceToBoundary ... | NaN | 1.9150 | 0.1503 | 1.8531 | 0.1287 |
| dip_degree | NaN | 89.2885 | 90.7231 | 89.0000 | 90.6384 |
| shoulder Vp_m/s | NaN | 4.2116e+03 | NaN | NaN | NaN |
| shoulder Vs_m/s | NaN | NaN | 3500 | NaN | NaN |
| Results | event_04 | refraction_ppp | refraction_sss | reflection_pp | reflection_ss |
| resnorm | NaN | 147.9774 | 6.6828e−04 | 5.0042 | ✓ 0.0000 |
| pCSG_usFt | 129.9091 | 72.3691 | 129.0100 | 49.8232 | 129.9091 |
| pCOG_usFt | 1.3279 | 0.0016 | 1.0298 | −19.3943 | 1.3279 |
| Tau_ms_matchTT | 1.9507 | 1.1139 | 1.9507 | 1.9452 | 1.9507 |
| timeLag_us | NaN | 3.6560e−04 | −0.0039 | 10.0000 | −0.0000 |
| distance ToBoundary ... | NaN | 2.5169 | 1.9148 | 11.7755 | 1.8531 |
| dip_degree | NaN | 89.9980 | 89.2885 | 98.6927 | 89.0000 |
| shoulder Vp_m/s | NaN | 4.2116e+03 | NaN | NaN | NaN |
| shoulder Vs_m/s | NaN | NaN | 2.3531e+03 | NaN | NaN |

TABLE 3
Summary of model selection procedure results for the four arrival events #1, #4, #7, and #11
from the field example shown in FIG. 20 marked in the measured depth interval described in the panels.
APPENDIX

| | | pCOG_{—} | pCRG_{—} | pCSG_{—} | Tau_ms_{—} | refraction_{—} | refraction_{—} | reflection_{—} | reflection_{—} |
|---|---|---|---|---|---|---|---|---|---|
| E | Tau_ms | usFt | usFt | usFt | matchTT | ppp | sss | pp | sss |
| 1 | 2.1387 | −0.2778 | 37.1429 | 127 | 2.0284 | 920.1020 | 19.1041 | 26.8806 | 0.6321 |
| 4 | 1.8987 | 0 | −88.5714 | 112 | 1.7884 | 539.2582 | ✓ 0.0000 | 17.1219 | 0.4752 |
| 7 | 1.1387 | −0.2778 | −88.5714 | 58 | 1.0284 | ✓ 0.0000 | 39.3003 | 0.0276 | 323.6218 |
| 11 | 1.3487 | −0.2778 | −88.5714 | 70 | 1.2384 | 48.7014 | 2.3955 | 0.9025 | 245.5047 |

TABLE 4
Details of model selection procedure results for event #4 and event #7 shown in Table 3.
Each panel shows the event index in the second column of the first row. The second column also
$repeats the {τ}^{*} , {s}_{COG}^{*} , {s}_{CSG}^{*} values listed in the corresponding row of Table 1. The last four columns$
of the first row of each table give the data misfit when inverting the travel times using Equations
13a-d, and those columns are color-coded according to the magnitude of the inversion misfit. The
last four rows of each table provide the inverted parameter values.
APPENDIX

| Results | event_01 | refraction_ppp | refraction_sss | reflection_pp | reflection_ss |
|---|---|---|---|---|---|
| resnorm | NaN | 539.2582 | ✓ 2.1148e−11 | 17.1219 | 0.4752 |
| pCSG_usFt | 112.0000 | 64.7657 | 111.9999 | 36.9319 | 124.4059 |
| pCOG_usFt | 0 | 0.0027 | −5.3356e−06 | −1.4325 | 0.2467 |
| Tau_ms_matchTT | 1.7884 | 1.0006 | 1.7884 | 1.7830 | 1.7914 |
| timeLag_us | NaN | 7.4367e−04 | −0.0102 | 20.0000 | −20.0000 |
| distance ToBoundary ... | NaN | 2.5308 | 1.9505 | 11.0226 | 1.5254 |
| dip_degree | NaN | 89.9963 | 90.0000 | 90.7142 | 89.7521 |
| shoulder Vp_m/s | NaN | 4.7061e+03 | NaN | NaN | NaN |
| shoulder Vs_m/s | NaN | NaN | 2.7214e+03 | NaN | NaN |
| Results | event_03 | refraction_ppp | refraction_sss | reflection_pp | reflection_ss |
| resnorm | NaN | ✓ 1.0338e−12 | 39.3003 | 0.0276 | 323.6218 |
| pCSG_usFt | 58.0000 | 58.0000 | 88.0600 | 61.0010 | 127.0060 |
| pCOG_usFt | 0.2778 | −0.2778 | −1.9581 | −0.2206 | −15.1694 |
| Tau_ms_matchTT | 1.0284 | 1.0284 | 1.2343 | 1.0290 | 1.6118 |
| timeLag_us | NaN | 0.0099 | −0.0280 | −20.0000 | −2.1773 |
| distance ToBoundary ... | NaN | 3.2215 | 0.2337 | 3.4183 | 0.8282 |
| dip_degree | NaN | 90.2227 | 90.6002 | 90.2088 | 101.7176 |
| shoulder Vp_m/s | NaN | 5.2677e+03 | NaN | NaN | NaN |
| shoulder Vs_m/s | NaN | NaN | 3500 | NaN | NaN |

1. A connector for use in a well, the connector comprising:
an external housing joined to a pair of coupler ends, each coupler end being combined with a sealing system and a separate retainer system, wherein the external housing with the sealing system and the separate retainer system are configured to slide together over a coupling joining a pair of electrical cable sections to form an electrical cable;
the sealing system, wherein the sealing system is formed at least in part of a shape memory alloy material selectively activatable to seal against the pair of electrical cable sections; and
the separate retainer system, wherein the separate retainer system is formed at least in part of the shape memory alloy material selectively activatable to grip the pair of electrical cable sections.

2. The connector as recited in claim 1, wherein the shape memory alloy material is a metal alloy material activatable via application of heat.

3. The connector as recited in claim 1, wherein the sealing system comprises a ring clamp having internal sealing teeth oriented towards one of the electrical cable sections, and wherein when the sealing system is activated, the ring clamp expands and forces the internal sealing teeth radially inward to seal against the pair of electrical cable sections.

4. The connector as recited in claim 1, wherein the separate retainer system comprises a plurality of retainer rings.

5. The connector as recited in claim 4, further comprising an inner housing, wherein the separate retainer system is bound radially between the inner housing and the pair of electrical cable sections, and wherein the separate retainer system is further bound axially between the sealing system and the inner housing, the separate retainer system being adjacent to the inner housing, the sealing system, and the pair of electrical cable sections.

6. The connector as recited in claim 5, wherein each retainer ring, of the plurality of retainer rings, comprises internal and external gripping surfaces.

7. The connector as recited in claim 1, wherein the connector is a dry mate type connector.

8. The connector as recited in claim 1, wherein the coupler ends are secured to the external housing via weldments.

9. A system for use in a well, the system comprising:
a pair of electrical cable sections joined via a coupling to form an electrical cable; and
a connector comprising:
an external housing joined to a pair of coupler ends, each coupler end being combined with a sealing system and a separate retainer system;
the sealing system, wherein the sealing system is:
formed at least in part of a shape memory alloy material selectively activatable to seal against the pair of electrical cable sections,
bound radially between the external housing and the electrical cable sections, the sealing system being adjacent to the external housing and the pair of electrical cable sections, and
bound axially between the coupler end, an inner housing of the connector, and the separate retainer system, wherein the sealing system is directly adjacent to the coupler end on a first side and directly adjacent the inner housing of the connector and the separate retainer system on an opposite side;
the separate retainer system, wherein the separate retainer system is formed at least in part of the shape memory alloy material selectively activatable to grip the pair of electrical cable sections; and
the inner housing.

10. The system as recited in claim 9, wherein the shape memory alloy material is a metal alloy material activatable via application of heat.

11. The system as recited in claim 9, wherein the sealing system comprises a ring clamp having internal sealing teeth oriented towards one of the electrical cable sections, and wherein when the sealing system is activated, the ring clamp expands and forces the internal sealing teeth radially inward to seal against the pair of electrical cable sections.

12. The system as recited in claim 9, wherein the separate retainer system comprises a plurality of retainer rings.

13. The system as recited in claim 12, wherein the separate retainer system is bound radially between the inner housing and the pair of electrical cable sections, and wherein the separate retainer system is further bound axially between the sealing system and the inner housing, the separate retainer system being adjacent to the inner housing, the sealing system, and the electrical cable sections.

14. The system as recited in claim 13, wherein each retainer ring, of the plurality of retainer rings, comprises internal and external gripping surfaces.

15. The system as recited in claim 9, wherein the connector is a dry mate type connector.

16. The system as recited in claim 9, wherein the coupler ends of the connector are secured to the external housing via weldments.

17. A system for use in a well, the system comprising:
an electrical cable joined to a gauge sensor via a coupling of the electrical cable and a gauge electrical connector; and
a connector comprising:
an external housing joined to a pair of coupler ends, each coupler end being combined with a sealing system and a separate retainer system, wherein the coupling and the gauge electrical connector are within the external housing;
the sealing system, wherein the sealing system is formed at least in part of a shape memory alloy material selectively activatable to seal against a pair of electrical cable sections forming the electrical cable; and
the separate retainer system, wherein the separate retainer system is formed at least in part of the shape memory alloy material selectively activatable to grip the pair of electrical cable sections, and wherein the external housing with the sealing system and the separate retainer system are configured to slide together over the coupling of the electrical cable and the gauge electrical connection.

18. The system as recited in claim 17, wherein the shape memory alloy material is a metal alloy material activatable via application of heat.

19. The system as recited in claim 17, wherein the sealing system comprises a ring clamp having internal sealing teeth oriented towards one of the electrical cable sections, and wherein when the sealing system is activated, the ring clamp expands and forces the internal sealing teeth radially inward to seal against the pair of electrical cable sections.

20. The system as recited in claim 17, wherein the separate retainer system comprises a plurality of retainer rings.
